(19) United States
(12) Patent Application Publication
(10) Pub. No.: US 2025/0039134 A1
(43) Pub. Date: Jan. 30, 2025

(54) TRUST SCORING WITH INTELLIGENT TRAFFIC FLOW AND LOAD BALANCING IN A NETWORK

(71) Applicant: Cisco Technology, Inc., San Jose, CA (US)

(72) Inventor: Eric Maximilian Roquemore, Austin, TX (US)

(21) Appl. No.: 18/625,874

(22) Filed: Apr. 3, 2024

Related U.S. Application Data
(60) Provisional application No. 63/516,448, filed on Jul. 28, 2023.

(51) Int. Cl. H04L 9/40

(52) U.S. Cl. CPC H04L 63/0236; H04L 63/123

(57) ABSTRACT

A system and method are provided for routing traffic through a network to ensure load balancing and avoid untrustworthy nodes. Based on network data (e.g., telemetry data), a machine learning model generates trust scores, which are used for routing decisions by determining preferred routes from a source to a destination. The trust scores for nodes along a potential route can be combined into a cumulative trust score. The potential route with the lowest cumulative trust score (i.e., most trustworthy) is preferred, when all other factors are equal. Traffic is routed along the preferred routes, until their capacity is exceeded. Then to achieve load balancing, traffic flows are extended to the next most preferred routes (e.g., the next lowest cumulative trust score), and so forth. When traffic flows include a mix of sensitive and non-sensitive data, the sensitive data is preferentially directed along the most preferred routes.

### CROSS-REFERENCE TO RELATED APPLICATIONS

This application priority to U.S. provisional application No. 63/716,448, titled “Data Processing Units (DPUs) and extended Berkley Packet Filters (eBPFs) for Improved Security,” and filed on Jul. 28, 2023, which is expressly incorporated by reference herein in its entirety.

### TECHNICAL FIELD

Aspects described herein generally relate to routing traffic through a network to ensure load balancing and avoid untrustworthy nodes, and, including, aspects related to using a machine learning model to generate trust scores, which are used for routing decisions by determining preferred routes from a source to a destination within the network.

### BACKGROUND

In a computer network, data flows through the network along paths/routes of connected nodes. Various protocols can be used to determine how to route traffic from a given source to a given destination. For example, the Interior Gateway Protocol (IGP) can route traffic using a link-state routing protocol such as the Open Shortest Path First (OSPF) or the Intermediate System to Intermediate System (IS-IS) protocols. Alternatively, IGP can route traffic using a distance-vector routing protocol such as Routing Information Protocol (RIP) or Interior Gateway Routing Protocol (IGRP). Additionally, the Border Gateway Protocol (BGP) is a standardized exterior gateway protocol designed to exchange routing and reachability information among autonomous systems (AS) on the Internet. BGP has its process for determining routes between sources and destinations.

Improved methods are desired to ensure that traffic through networks is not routed through nodes that are not trustworthy or that have been compromised, for example.

### BRIEF DESCRIPTION OF THE SEVERAL VIEWS OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example of a first path from a source to a destination within an network, in accordance with certain embodiments.

FIG. 1B illustrates an example of a second path from a source to a destination within a network, in accordance with certain embodiments.

FIG. 1C illustrates an example of a third path from a source to a destination within a network, in accordance with certain embodiments.

FIG. 2 illustrates a block diagram of an example of a data center, in accordance with certain embodiments.

FIG. 3A illustrates a block diagram of a first example of a network, in accordance with certain embodiments.

FIG. 3B illustrates a block diagram of a second example of a network, in accordance with certain embodiments.

FIG. 4 illustrates an example of a network that includes multiple autonomous systems, in accordance with certain embodiments.

FIG. 5A illustrates a block diagram of an example of an extended Berkeley packet filter (eBPF) architecture, in accordance with some embodiments.

FIG. 5B illustrates a block diagram of another example of an eBPF architecture, in accordance with some embodiments.

FIG. 6 illustrates a flow diagram of a method for determining and using trust scores for routing data flows in a network, in accordance with some embodiments.

FIG. 7A illustrates a block diagram of an example of training a machine learning (ML) model to determine trust scores, in accordance with some embodiments.

FIG. 7B illustrates a block diagram of an example of using the trained ML model to determine trust scores, in accordance with some embodiments.

FIG. 8 illustrates a block diagram of a computing device, in accordance with some embodiments.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In some aspects, the techniques described herein relate to a method of routing traffic in a network based on trust scores, the method including: assigning trust scores to respective nodes within a network; determining, based on the trust scores, one or more preferred routes for one or more data packets through the network, the one or more preferred routes starting a first node and ending at a second node, and the one or more preferred routes being determined based on a respective cumulative metric for each potential route that accounts for the trust scores of nodes along the potential route; and routing the one or more data packets along the one or more preferred routes based at least in part on load balancing a volume of traffic.

In some aspects, the techniques described herein relate to a method, wherein determining the one or more preferred routes based on the trust scores further includes: determining the one or more preferred routes based on the trust scores and based on a degree of data sensitivity of the one or more data packets, such that load balancing is achieved by: routing a first traffic flow of the one or more data packets along a first route, wherein the first traffic flow has a higher degree of the data sensitivity than a second traffic flow, and routing a part of the second traffic flow along a second route that is less trustworthy than the first route, when a packet routing capacity of the first route is exceeded by a combination of the first traffic flow and the second traffic flow.

In some aspects, the techniques described herein relate to a method, wherein assigning the trust scores to respective nodes within the network further includes: receiving, at one or more processors, network data representing indicia of trustworthiness at the respective nodes of the network; applying the network data of a first node to a first machine learning (ML) model to determine a first trust score representing a reliability of the first node for timely transmitting data through the first node while preserving an integrity of the data, and repeating for each of the respective nodes of the network to determine the trust scores using the ML model; and assigning the determined trust scores to the respective nodes of the network.

In some aspects, the techniques described herein relate to a method, wherein the network data for a given node of the network compromises one or more of: (i) telemetry data from the given node; (ii) packet latency through the given node; (iii) packet loss rate at the given node; (iv) results of deep packet inspection at the given node; (v) a number of successful transactions the given node; (vi) response time of the given node; (vii) incidence of security breaches or data leak at the given node; (viii) a software version installed on the given node; (ix) security patches installed on the given node; (x) detections of potential security threats, vulnerabilities, bugs, or attacks; exposures to other nodes suspected of compromise; (xi) number of connections to neighboring nodes; (xii) time of operating in a proper manner; (xiii) network policies at the given node; (xiv) statistical fluctuations in performance at the given node; and/or (xv) anomalous events detected at the given node.

In some aspects, the techniques described herein relate to a method, wherein determining the one or more preferred routes based on the trust scores further includes: optimizing an objective function that includes a trust term and a load balancing term, the objective function representing scores for potential routes, wherein the trust term for a potential route combines the trust scores of the nodes along the potential route into the cumulative metric, and the load balancing term accounts for bottlenecks and limitations arising from traffic-flow capacities of the potential route.

In some aspects, the techniques described herein relate to a method, wherein the cumulative metric is an L^{p}-norm of the trust scores of the nodes along the potential route.

In some aspects, the techniques described herein relate to a method, wherein the objective function is a weighted combination including the trust term and the load balancing terms, and weights for the weighted combination are based on a degree of data sensitivity and/or data criticality of the one or more data packets.

In some aspects, the techniques described herein relate to a method, wherein the ML model includes a decision tree model, a regression model, a classifier model, a clustering model, a K-means clustering model, a K-nearest neighbor clustering model, a Q-learning model, a large language model, or a transformer model.

In some aspects, the techniques described herein relate to a method, wherein assigning the trust scores to respective nodes within the network further includes: receiving, at one or more processors, network data representing indicia of trustworthiness at the respective nodes of the network; and applying the network data of a first node to a first machine learning (ML) model to determine a first trust score, and repeating for each of the respective nodes of the network to determine the trust scores using the ML model, wherein the ML model is operated in a learning phase and an application phase, in the learning phase, the trust scores are nascent trust scores that are used for routing decisions in an exploration mode to explore a trust landscape and gather more information regarding what aspects of the network data represent trustworthiness of the respective nodes, and in the application phase, the trust scores are mature trust scores that are used for routing decisions in an exploitation mode to direct traffic flows along routes that are determined to be most trustworthy based on the trust scores.

In some aspects, the techniques described herein relate to a method, wherein determining the one or more preferred routes based on the trust scores further includes: determining the one or more preferred routes piecewise by: determining, for each local region of the network, one or more preferred route segments through a local region of the network; and stitching the one or more preferred route segments from a first local region with the one or more preferred route segments from one or more other local regions to form the one or more preferred routes.

In some aspects, the techniques described herein relate to a method, further including: determining whether a trust score of a node is within a first range of values, a second range of values, and/or a third range of values; treating the node as compromised by quarantining the node, when the trust score of the node is within the first range of values; treating the node as suspicious, when the trust score of the node is within the second range of values, by adding observability functions to the node that provide additional information regarding potential problems on the node; and treating the node as normal, when the trust score of the node is within the second range of values, by continuing to monitor the network data from the node and updating a value of the trust score of the node based on the network data.

In some aspects, the techniques described herein relate to a method, wherein, when the trust score of the node is within the first range of values, the node remains quarantined until remediating action is applied to the node to address a detected problem, the remediating action including additional testing of the node in a sandbox, scanning the node to detect and eradicate malicious software, or applying one or more security patches or policies that are responsive to the detected problem.

In some aspects, the techniques described herein relate to a method, wherein assigning the trust scores to respective nodes within the network further includes: receiving, at the one or more processors, location information representing indicia of locations of the respective nodes within the network; and applying the network data and the location information corresponding to the first node to the ML model to determine the first trust score, and repeating for each of the respective nodes of the network to determine the trust scores using the ML model, wherein the ML model is trained to associate different locations within the network with respective likelihoods of being trustworthy.

In some aspects, the techniques described herein relate to a method, wherein the ML model is trained to discriminate which nodes are exhibiting anomalous behaviors and/or which nodes are behaving erratically, and the trust scores of such nodes are adjusted to indicate less trustworthiness.

In some aspects, the techniques described herein relate to a method, further including: continuously training the ML model to recognize indicia of untrustworthiness in the network data by: detecting and signaling portions of the network data corresponding to anomalous behaviors; receiving feedback labeling the portions of the network data with labels including true positives or false positives to generate reinforcement training data; and/or performing reinforcement training on the ML model using the reinforcement training data.

In some aspects, the techniques described herein relate to a computing apparatus including: a processor; and a memory storing instructions that, when executed by the processor, configure the apparatus to: assign trust scores to respective nodes within a network; determine, based on the trust scores, one or more preferred routes for one or more data packets through the network, the one or more preferred routes starting a first node and ending at a second node, and the one or more preferred routes being determined based on a respective cumulative metric for each potential route that accounts for the trust scores of nodes along the potential route; and route the one or more data packets along the one or more preferred routes based at least in part on load balancing a volume of traffic.

In some aspects, the techniques described herein relate to a computing apparatus, wherein the instructions stored in the memory, when executed by the processor, further configure the apparatus to determine the one or more preferred routes based on the trust scores by: determining the one or more preferred routes based on the trust scores and based on a degree of data sensitivity of the one or more data packets, such that load balancing is achieved by: routing a first traffic flow of the one or more data packets along a first route, wherein the first traffic flow has a higher degree of the data sensitivity than a second traffic flow, and routing a part of the second traffic flow along a second route that is less trustworthy than the first route, when a packet routing capacity of the first route is exceeded by a combination of the first traffic flow and the second traffic flow.

In some aspects, the techniques described herein relate to a computing apparatus, wherein the instructions stored in the memory, when executed by the processor, further configure the apparatus to assign the trust scores to respective nodes within the network by: receiving, at one or more processors, network data representing indicia of trustworthiness at the respective nodes of the network; applying the network data of a first node to a first machine learning (ML) model to determine a first trust score representing a reliability of the first node for timely transmitting data through the first node while preserving an integrity of the data, and repeating for each of the respective nodes of the network to determine the trust scores using the ML model; and assigning the determined trust scores to the respective nodes of the network.

In some aspects, the techniques described herein relate to a computing apparatus, wherein the network data for a given node of the network compromises one or more of: (i) telemetry data from the given node; (ii) packet latency through the given node; (iii) packet loss rate at the given node; (iv) results of deep packet inspection at the given node; (v) a number of successful transactions the given node; (vi) response time of the given node; (vii) incidence of security breaches or data leak at the given node; (viii) a software version installed on the given node; (ix) security patches installed on the given node; (x) detections of potential security threats, vulnerabilities, bugs, or attacks; exposures to other nodes suspected of compromise; (xi) number of connections to neighboring nodes; (xii) time of operating in a proper manner; (xiii) network policies at the given node; (xiv) statistical fluctuations in performance at the given node; or (xv) anomalous events detected at the given node.

In some aspects, the techniques described herein relate to a computing apparatus, wherein the instructions stored in the memory, when executed by the processor, further configure the apparatus to determine the one or more preferred routes based on the trust scores by: optimizing an objective function that includes a trust term and a load balancing term, the objective function representing scores for potential routes, wherein the trust term for a potential route combines the trust scores of the nodes along the potential route into the cumulative metric, and the load balancing term accounts for bottlenecks and limitations arising from traffic-flow capacities of the potential route.

In some aspects, the techniques described herein relate to a computing apparatus, wherein the cumulative metric is an Lp-norm of the trust scores of the nodes along the potential route.

In some aspects, the techniques described herein relate to a computing apparatus, wherein the objective function is a weighted combination including the trust term and the load balancing terms, and weights for the weighted combination are based on a degree of data sensitivity and/or data criticality of the one or more data packets.

In some aspects, the techniques described herein relate to a computing apparatus, wherein the ML model includes a decision tree model, a regression model, a classifier models, a clustering model, a K-means clustering model, a K-nearest neighbor clustering model, a Q-learning model, a large language model, or a transformer model.

In some aspects, the techniques described herein relate to a computing apparatus, wherein the instructions stored in the memory, when executed by the processor, further configure the apparatus to assign the trust scores to respective nodes within the network by: receiving, at one or more processors, network data representing indicia of trustworthiness at the respective nodes of the network; and applying the network data of a first node to a first machine learning (ML) model to determine a first trust score, and repeating for each of the respective nodes of the network to determine the trust scores using the ML model, wherein the ML model is operated in a learning phase and an application phase, in the learning phase, the trust scores are nascent trust scores that are used for routing decisions in an exploration mode to explore a trust landscape and gather more information regarding what aspects of the network data represent trustworthiness of the respective nodes, and in the application phase, the trust scores are mature trust scores that are used for routing decisions in an exploitation mode to direct traffic flows along routes that are determined to be most trustworthy based on the trust scores.

In some aspects, the techniques described herein relate to a computing apparatus, wherein the instructions stored in the memory, when executed by the processor, further configure the apparatus to determine the one or more preferred routes based on the trust scores by: determining the one or more preferred routes piecewise by: determining, for each local region of the network, one or more preferred route segments through a local region of the network; and stitching the one or more preferred route segments from a first local region with the one or more preferred route segments from one or more other local regions to form the one or more preferred routes.

In some aspects, the techniques described herein relate to a computing apparatus, wherein the instructions stored in the memory, when executed by the processor, further configure the apparatus to: determine whether a trust score of a node is within a first range of values, a second range of values, or a third range of values; treat the node as compromised by quarantining the node, when the trust score of the node is within the first range of values; treat the node as suspicious, when the trust score of the node is within the second range of values, by adding observability functions to the node that provide additional information regarding potential problems on the node; and treat the node as normal, when the trust score of the node is within the second range of values, by continuing to monitor the network data from the node and updating a value of the trust score of the node based on the network data.

In some aspects, the techniques described herein relate to a computing apparatus, wherein, when the trust score of the node is within the first range of values, the node remains quarantined until remediating action is applied to the node to address a detected problem, the remediating action including additional testing of the node in a sandbox, scanning the node to detect and eradicate malicious software, or applying one or more security patches or policies that are responsive to the detected problem.

In some aspects, the techniques described herein relate to a computing apparatus, wherein the instructions stored in the memory, when executed by the processor, further configure the apparatus to assign the trust scores to respective nodes within the network by: receiving, at the one or more processors, location information representing indicia of locations of the respective nodes within the network; and applying the network data and the location information corresponding to the first node to the ML model to determine the first trust score, and repeating for each of the respective nodes of the network to determine the trust scores using the ML model, wherein the ML model is trained to associate different locations within the network with respective likelihoods of being trustworthy.

In some aspects, the techniques described herein relate to a computing apparatus, wherein the ML model is trained to discriminate which nodes are exhibiting anomalous behaviors and/or which nodes are behaving erratically, and the trust scores of such nodes are adjusted to indicate less trustworthiness.

In some aspects, the techniques described herein relate to a computing apparatus, wherein the instructions stored in the memory, when executed by the processor, further configure the apparatus to: continuously train the ML model to recognize indicia of untrustworthiness in the network data by: detecting and signaling portions of the network data corresponding to anomalous behaviors; receiving feedback labeling the portions of the network data with labels including true positives or false positives to generate reinforcement training data; and performing reinforcement training on the ML model using the reinforcement training data.

In some aspects, the techniques described herein relate to a non-transitory computer-readable storage medium, the computer-readable storage medium including instructions that when executed by a computer, cause the computer to: assign trust scores to respective nodes within a network; determine, based on the trust scores, one or more preferred routes for one or more data packets through the network, the one or more preferred routes starting a first node and ending at a second node, and the one or more preferred routes being determined based on a respective cumulative metric for each potential route that accounts for the trust scores of nodes along the potential route; and route the one or more data packets along the one or more preferred routes based at least in part on load balancing a volume of traffic.

In some aspects, the techniques described herein relate to a non-transitory computer-readable storage medium, wherein the instructions on the computer-readable storage medium, when executed by the processor, further configure the apparatus to determine the one or more preferred routes based on the trust scores by: determining the one or more preferred routes based on the trust scores and based on a degree of data sensitivity of the one or more data packets, such that load balancing is achieved by: routing a first traffic flow of the one or more data packets along a first route, wherein the first traffic flow has a higher degree of the data sensitivity than a second traffic flow, and routing a part of the second traffic flow along a second route that is less trustworthy than the first route, when a packet routing capacity of the first route is exceeded by a combination of the first traffic flow and the second traffic flow.

In some aspects, the techniques described herein relate to a non-transitory computer-readable storage medium, wherein the instructions on the computer-readable storage medium, when executed by the processor, further configure the apparatus to assign the trust scores to respective nodes within the network by: receiving, at one or more processors, network data representing indicia of trustworthiness at the respective nodes of the network; applying the network data of a first node to a first machine learning (ML) model to determine a first trust score representing a reliability of the first node for timely transmitting data through the first node while preserving an integrity of the data, and repeating for each of the respective nodes of the network to determine the trust scores using the ML model; and assigning the determined trust scores to the respective nodes of the network.

In some aspects, the techniques described herein relate to a non-transitory computer-readable storage medium, wherein the network data for a given node of the network compromises one or more of: (i) telemetry data from the given node; (ii) packet latency through the given node; (iii) packet loss rate at the given node; (iv) results of deep packet inspection at the given node; (v) a number of successful transactions the given node; (vi) response time of the given node; (vii) incidence of security breaches or data leak at the given node; (viii) a software version installed on the given node; (ix) security patches installed on the given node; (x) detections of potential security threats, vulnerabilities, bugs, or attacks; exposures to other nodes suspected of compromise; (xi) number of connections to neighboring nodes; (xii) time of operating in a proper manner; (xiii) network policies at the given node; (xiv) statistical fluctuations in performance at the given node; or (xv) anomalous events detected at the given node.

In some aspects, the techniques described herein relate to a non-transitory computer-readable storage medium, wherein the instructions on the computer-readable storage medium, when executed by the processor, further configure the apparatus to determine the one or more preferred routes based on the trust scores by: optimizing an objective function that includes a trust term and a load balancing term, the objective function representing scores for potential routes, wherein the trust term for a potential route combines the trust scores of the nodes along the potential route into the cumulative metric, and the load balancing term accounts for bottlenecks and limitations arising from traffic-flow capacities of the potential route.

In some aspects, the techniques described herein relate to a non-transitory computer-readable storage medium, wherein the cumulative metric is an Lp-norm of the trust scores of the nodes along the potential route.

In some aspects, the techniques described herein relate to a non-transitory computer-readable storage medium, wherein the objective function is a weighted combination including the trust term and the load balancing terms, and weights for the weighted combination are based on a degree of data sensitivity and/or data criticality of the one or more data packets.

In some aspects, the techniques described herein relate to a non-transitory computer-readable storage medium, wherein the ML model includes a decision tree model, a regression model, a classifier models, a clustering model, a K-means clustering model, a K-nearest neighbor clustering model, a Q-learning model, a large language model, or a transformer model.

In some aspects, the techniques described herein relate to a non-transitory computer-readable storage medium, wherein the instructions on the computer-readable storage medium, when executed by the processor, further configure the apparatus to assign the trust scores to respective nodes within the network by: receiving, at one or more processors, network data representing indicia of trustworthiness at the respective nodes of the network; and applying the network data of a first node to a first machine learning (ML) model to determine a first trust score, and repeating for each of the respective nodes of the network to determine the trust scores using the ML model, wherein the ML model is operated in a learning phase and an application phase, in the learning phase, the trust scores are nascent trust scores that are used for routing decisions in an exploration mode to explore a trust landscape and gather more information regarding what aspects of the network data represent trustworthiness of the respective nodes, and in the application phase, the trust scores are mature trust scores that are used for routing decisions in an exploitation mode to direct traffic flows along routes that are determined to be most trustworthy based on the trust scores.

In some aspects, the techniques described herein relate to a non-transitory computer-readable storage medium, wherein the instructions on the computer-readable storage medium, when executed by the processor, further configure the apparatus to determine the one or more preferred routes based on the trust scores by: determining the one or more preferred routes piecewise by: determining, for each local region of the network, one or more preferred route segments through a local region of the network; and stitching the one or more preferred route segments from a first local region with the one or more preferred route segments from one or more other local regions to form the one or more preferred routes.

In some aspects, the techniques described herein relate to a non-transitory computer-readable storage medium, wherein the instructions on the computer-readable storage medium, when executed by the processor, further configure the apparatus to: determine whether a trust score of a node is within a first range of values, a second range of values, or a third range of values; treat the node as compromised by quarantining the node, when the trust score of the node is within the first range of values; treat the node as suspicious, when the trust score of the node is within the second range of values, by adding observability functions to the node that provide additional information regarding potential problems on the node; and treat the node as normal, when the trust score of the node is within the second range of values, by continuing to monitor the network data from the node and updating a value of the trust score of the node based on the network data.

In some aspects, the techniques described herein relate to a non-transitory computer-readable storage medium, wherein, when the trust score of the node is within the first range of values, the node remains quarantined until remediating action is applied to the node to address a detected problem, the remediating action including additional testing of the node in a sandbox, scanning the node to detect and eradicate malicious software, or applying one or more security patches or policies that are responsive to the detected problem.

In some aspects, the techniques described herein relate to a non-transitory computer-readable storage medium, wherein the instructions on the computer-readable storage medium, when executed by the processor, further configure the apparatus to assign the trust scores to respective nodes within the network by: receiving, at the one or more processors, location information representing indicia of locations of the respective nodes within the network; and applying the network data and the location information corresponding to the first node to the ML model to determine the first trust score, and repeating for each of the respective nodes of the network to determine the trust scores using the ML model, wherein the ML model is trained to associate different locations within the network with respective likelihoods of being trustworthy.

In some aspects, the techniques described herein relate to a non-transitory computer-readable storage medium, wherein the ML model is trained to discriminate which nodes are exhibiting anomalous behaviors and/or which nodes are behaving erratically, and the trust scores of such nodes are adjusted to indicate less trustworthiness.

In some aspects, the techniques described herein relate to a non-transitory computer-readable storage medium, wherein the instructions on the computer-readable storage medium, when executed by the processor, further configure the apparatus to: continuously train the ML model to recognize indicia of untrustworthiness in the network data by: detecting and signaling portions of the network data corresponding to anomalous behaviors; receiving feedback labeling the portions of the network data with labels including true positives or false positives to generate reinforcement training data; and performing reinforcement training on the ML model using the reinforcement training data.

### EXAMPLE EMBODIMENTS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The disclosed technology addresses the need in the art for improved methods of routing traffic through a network to ensure load balancing and avoid routes through untrustworthy nodes in the network. Based on network data (e.g., telemetry data) from the respective nodes, a machine learning (ML) model can generate trust scores. These trust scores can then be used to inform routing decisions for preferred routes for traffic flows from a source to a destination within the network.

According to certain non-limiting examples, cumulative trust scores can be generated for potential routes by combining the trust scores of the nodes along the routes. When the convention is adopted that a lower value of the trust score means that the node is more trustworthy, a route with a lower cumulative trust score can be preferred over a route with a higher cumulative trust score, when all other factors are equivalent between the two potential routes.

According to certain non-limiting examples, when traffic volumes are low, the traffic flow can be limited to the preferred routes. But as traffic volume increases on the network, the traffic flow can be expanded to the next most preferred routes, in addition to the most preferred routes, to provide load balancing and to avoid exceeding the capacity of the most preferred routes.

Further, according to certain non-limiting examples, the data flows can include a mix of sensitive and non-sensitive data traffic flowing through the network. When the sensitive data can be distinguished from the non-sensitive data (e.g., based on the information in the packet header), then the sensitive data can be routed along the most preferred routes, as determined based on the trust scores. The non-sensitive data can be routed along the most preferred routes, when allowed by the flow capacity of the most preferred routes. And the non-sensitive data can be routed along the next most preferred routes, when needed to achieve load balancing.

To illustrate an example of using trust scores a path in a network 100 to determine from a source router/node (e.g., router R1 102) to a destination router/node (e.g., router R7 114). For illustrative purposes, the nodes with lower values for their trust score are indicated as black, and the nodes with higher values for their trust score are indicated as grey. Here, the convention is adopted that a lower value for a trust score indicates that the node is believed to be more trustworthy. However, a person of ordinary skill in the art would recognize that the opposite convention (i.e., higher trust score values correspond to increased more trustworthiness) without departing from the spirit of the disclosure. Each node (e.g., a server or router) in the network 100 can be evaluated based on various parameters like connection stability, frequency of activity, response time, and data integrity. This evaluation results in a dynamic trust score for each node.

According to certain non-limiting examples, network 100 can be a distributed network that provides connectivity for servers hosting a multiplayer game where the nodes are servers/routers that are geographically dispersed. For example, the game can involve both general data (e.g., player movements, game physics, etc.) and sensitive data (e.g., personally identifiable information, financial information for in-game purchases, etc.). According to certain non-limiting examples, the network can implement peer-to-peer (P2P) trust scoring, intelligent traffic flow, and load balancing.

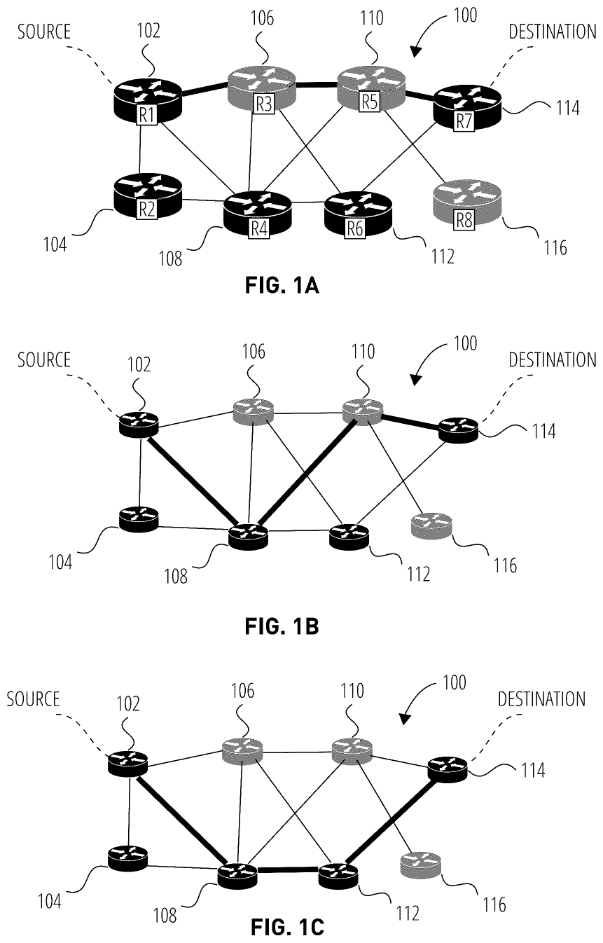

In the non-limiting example illustrated in FIG. 1A, R3 106 can be a server/router that is located in Asia and has a low trust score (high trustworthiness) due to its stable connection, fast response time, and a history of handling data with integrity. In contrast, R4 108 can be a server/router located in Europe that has a higher trust score (lower trustworthiness) due to recent connectivity issues, for example. Additionally, in this example, nodes R1 102, R2 104, R6 112, and R7 114 have low trust scores (i.e., high trustworthiness), and nodes R5 110 and R8 116 have higher trust score (lower trustworthiness). The lines between nodes represent connections via which data packets can be sent between nodes.

The bold lines in FIG. 1A illustrate a first potential route (i.e., R1-R3-R5-R7) from the source node to the destination node. Similarly, the bold lines in FIG. 1B illustrate a second potential route (i.e., R1-R4-R6-R7) from the source node to the destination node, and the bold lines in FIG. 1C illustrate a third potential route (i.e., R1-R4-R5-R7) from the source node to the destination node. From the perspective of hop count, each of these potential routes has the same number of hops (e.g., as shown, three hops). According to certain non-limiting examples, the trust scores can be used to select which of the three potential routes is preferred.

For the first potential route (i.e., R1-R3-R5-R7, which is illustrated in FIG. 1A), the data packets would traverse two nodes (i.e., R3 106 and R5 110) that have higher trust score (lower trustworthiness). For the second potential route (i.e., R1-R4-R6-R7, which is illustrated in FIG. 1B), the data packets would traverse one node (i.e., R5 110) that has a higher trust score (lower trustworthiness). For the third potential route (i.e., R1-R4-R6-R7, which is illustrated in FIG. 1C), the data packets would traverse zero nodes that have a higher trust score (lower trustworthiness). Accordingly, a ranking of the potential routes would have the third potential route as the preferred route with the first route as the least preferred route.

According to certain non-limiting examples, network 100 can continuously monitor live traffic data through the nodes of network 100. When traffic volume is low all (or most) of the traffic can be routed along the preferred routes. For example, most of the traffic can be routed along the third potential route (i.e., R1-R4-R6-R7) with some traffic (as needed) being routed through the second potential route (i.e., R1-R4-R6-R7) and even less (or no) traffic routed through the first potential route (i.e., R1-R3-R5-R7). These three potential routes are examples of equal-cost multi-path (ECMP) routing. Other routes having higher hop counts are possible, but these are not considered the following analysis. Generally, each additional node adds risks by providing additional opportunities for cybersecurity threats, data compromise, and additional delays. In some cases, it may be optimal to route packets along a route with more nodes (i.e., an increased hop count) to avoid a node that has a very high trust score (low trustworthiness) or introduces significant packet delays (e.g., large packet latency). Often, however, the preferred route will have the lowest hop count and have the lowest cumulative trust score, which is the case of the example illustrated in FIGS. 1A-1C.

Depending on whether R4 108 can process a greater throughput than R6 112, the second potential route might not alleviate a bottleneck presented by limitations of the third potential route to handle a given throughput of data. For example, if the third potential route has reached its capacity (e.g., because R6 112 is the limiting bottleneck), but R4 108 still has additional capacity to route additional traffic, then the second potential route provides a potential option for load balancing to alleviate the demands on the third potential route. If, however, the third potential route has reached its capacity (e.g., because R4 108 is the limiting bottleneck), and R4 108 lacks the additional capacity to route additional traffic, then the second potential route does not provide a potential option for load balancing because R4 108 is common to both routes, such that moving traffic from the third potential route to the second potential route does not reduce the amount of traffic through the bottleneck (i.e., R4 108). In this case, load balancing might be realized by directing traffic through the first potential route rather than through the third potential route.

Load balancing can be realized as demands for routing resources ebb and flow as a function of time. Returning to the example of the multiplayer online game, the network 100 can experience a surge in routing demand due to increased gameplay data arising, e.g., from a special event in the game. Considering the trust scores, network 100 can initially (i.e., while routing demand is still moderate) route a majority of the traffic through the third potential route.

In the example of the multiplayer online game, as the event gains popularity, the load on the third potential route increases. Network 100 can achieve load balancing by directing an increasing amount of traffic towards the first potential route (assuming that R4 108 forms part of the bottleneck in the third potential route), even though the first potential route has a higher composite trust score than the third potential route. This load balancing can ensure the gameplay remains smooth for all players by avoiding dropped packets and avoiding lag due to packet latency. Thus, network 100 is able to beneficially balance the load while considering trust scores.

Network 100 can also account for the sensitivity or criticality of information conveyed in the data packets. For example, the data packets can include a value in their header or other indicia of which packets include sensitive or critical information. As discussed above, data packets that include personally identifiable information or financial information might be identified as sensitive. Additionally or alternatively, in video compression I-frames are more critical than P-frames, which are in turn more critical than B-frames. For example, I-frames can be decoded without depending on any other frames, whereas decoding P-frames depends on I-frames. Generally, decoding B-frames depend on both I-frames and P-frames, but no other frames depend on B-frames. Consequently, if an I-frame is dropped none of the subsequent frames can be decoded until the next I-frame, which can impact 8 or more frames. In contrast, dropping one of the B-frames only impacts that one B-frame.

Network 100 can route more sensitive/critical data packets along the preferred routes (i.e., routes with nodes having lower values for their trust scores, which according to the convention adopted herein are more trustworthy nodes). In the online game example, a batch of in-game purchase transactions, which are indicated as being sensitive data, can be preferentially routed through the third potential route, whereas data packets that are less sensitive can be routed through the first potential route. Thus, network 100 accounts for the sensitivity of the data when routing the in-game purchase transactions exclusively through the third potential route based on its lower trust score. If the load on the third potential route increases significantly or the trust score on the nodes of the third potential route increases for some reason (e.g., one of the nodes starts behaving erratically or the packet latency through the node increases significantly), network 100 can dynamically reevaluate the trust scores, potentially resulting in a different ranking of the potential routes and dynamically rerouting the traffic accordingly. For example, the traffic can be dynamically rerouted through other nodes that have low trust scores (high trustworthiness) to maintain optimal performance and security.

According to certain non-limiting examples, the network 100 is used to route data packets that are categorized either discreetly or continuously into two or more degrees/ranges of sensitivity and/or criticality, and an indicia of the sensitivity and/or criticality is provided with the data packet. For example, when the data packet has a payload that includes compressed video data, the data packet can include information in a header that indicates whether the compressed video data is for an I-frame, a P-frame, or a B-frame. Additionally or alternatively, indicating which packets not to drop is beneficial for many data types in addition to video data. Thus, it is beneficial to provide information regarding the importance of various data packets that is both accessible at the level of the data packet (e.g., in a Real-time Transport Protocol (RTP) header or a Network Abstraction Layer (NAL) header) and that is universal for more than just video data.

For example, in 3GPP, the extended reality and multimedia enhancement project (XRM) is considering meta-data exposure of media packets in which media frame awareness is brought into the network. In this context, a protocol data unit set (PDU-SET) associates together Protocol Data Units (PDUs) that are carrying the payload of one unit of information generated at the application level (e.g. a frame or video slice for XRM Services). The meta-data from the media packets (e.g., RTP or NAL headers) is used for binding frames to a PDU-SET and as well a definition for new quality of service (QOS) attributes such as a PDU Set Delay budget. This allows the network to drop certain packets when there is congestion in the Radio gNB (RAN). Neither XRM nor 3GPP nor any other network provides nor contemplates functionality where reliability features of the network are activated based on the importance of the frame and in relation to the other frames.

According to certain non-limiting examples, network 100 uses a machine learning (ML) model to evaluate data received from the nodes (e.g., telemetry) to determine trust scores for the respective nodes, and network 100 assigns a trust score to each node. The network 100 can then dynamically determine the preferred routes from a given source to a given destination based on the traffic volume, the data sensitivity and/or criticality, and the trust scores for each server, and the network 100 can adjust the routing accordingly. The preferred routes can be determined by optimizing an objective function or the equivalent. For example, the objective function can include a trust term, a load-balancing term, and other terms (e.g., a price term and an energy consumption/environmental term). The trust term can be calculated, e.g., using an L^{p}-norm of trust scores along the potential routes, which can be calculated as,

$$CTS = {( {\sum }_{n = 1 …N} {\vert {ts}_{n} \vert}^{p} )}^{1 / p} ,$$

wherein CTS is the cumulative trust score of a potential route with N nodes, tsₙ is the trust score of the n^{th} node, and p is a power corresponding to the L^{p}-norm. For example, when p=1 (i.e., the L¹-norm), the CTS is the sum of the trust scores along the potential route. When p=0 (i.e., the L⁰-norm), the CTS reduces to the hop count. When p=∞ (i.e., the L^{∞}-norm), the CTS returns the maximum trust score along the potential route (e.g., CTS=max(ts₁, ts₂, . . . , ts_{N})). When p=2 (i.e., the L²-norm), the CTS returns the Euclidean distance for a vector of length N (e.g., CTS=\sqrt{ts₁²+ts₂²+ . . . ts_{N}²}).

According to certain non-limiting examples, the objective function can be a weighted combination of respective terms, e.g.,

$$O ( {p}_{j} , {r}_{i} ) = {w}_{1} ( {p}_{j} ) LB ( {r}_{i} ) + {w}_{2} ( {p}_{j} ) CTS ( {r}_{i} ) + {w}_{3} ( {p}_{j} ) etc ,$$

wherein O(pⱼ, rᵢ) is the objective function, which is a function of the route rᵢ and the packet type pⱼ (e.g., pⱼ can be a certain class of packets that have a predefined sensitivity and/or a predefined criticality), LB(rᵢ) is the load balancing term, which is a function of the route rᵢ, CTS(rᵢ) is the cumulative trust score, which is a function of the route rᵢ, etc. is a place holder for the other terms if any (e.g., a price term and an energy consumption/environmental term), and wₘ(pⱼ) for m=1 . . . , 3 are weights applied to the respective terms. In this non-limiting example, the weights are functions of the packet type. For example, packet types with a higher degree of criticality or higher degree of sensitivity can have greater values for the weight w₂(pⱼ) applied to the trust scores to thereby select more trustworthy routes for this packet type, while other packet types might be directed along less trustworthy routes to achieve load balancing.

According to certain non-limiting examples, the nodes send data (e.g., telemetry data) to network 100, and one or more processors in network 100 apply the data to a trust-scoring model (e.g., a machine learning (ML) model) that evaluates this data and assigns trust scores to each of the nodes. For example, in a network that is executing a gateway protocol (e.g., the border gateway protocol (BGP) or an interior gateway protocol (IGP)), the data can be sent to a central controller such as Segment Routing Path Computation Element (SR-PCE), which applies the data to the trust-scoring model to thereby assign the trust scores. For example, when determining the preferred path(s) (e.g., the optimal-trustworthy paths), the methods and systems disclosed herein can use the trust score to provide improvements to the current Interior Gateway Protocol (IGP) routing protocols (e.g., Open Shortest Path First (OSPF), Intermediate System to Intermediate System (IS-IS), or Dijkstra's algorithm) to account for which nodes trustworthy, load balancing, and minimizing hop count, e.g., while selecting the routing path.

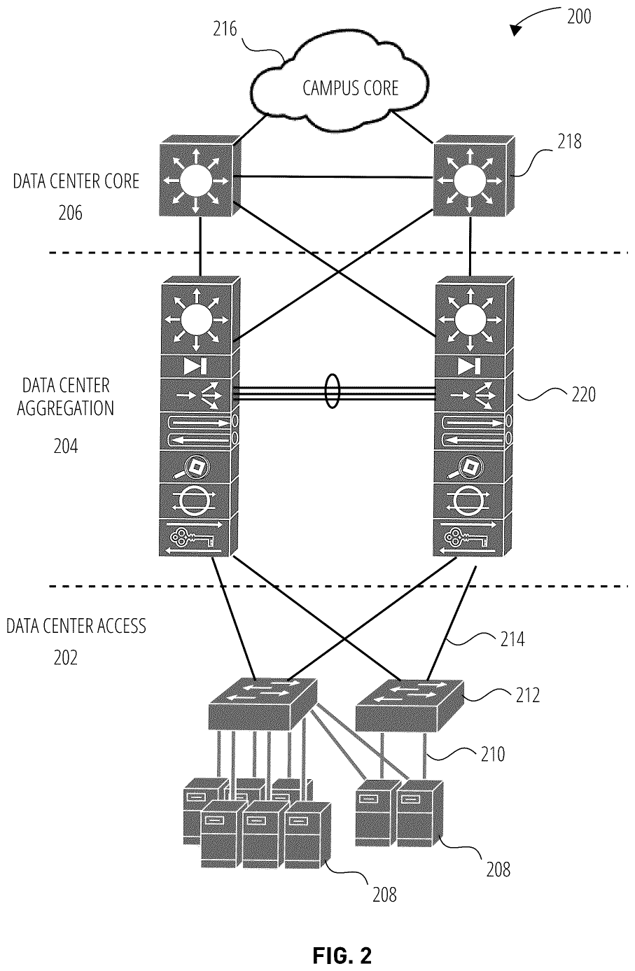

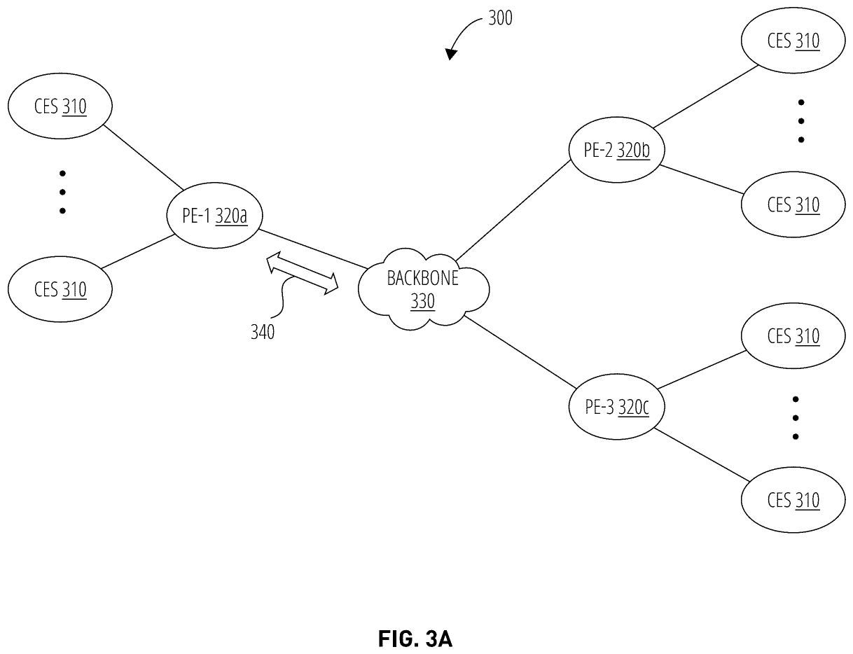

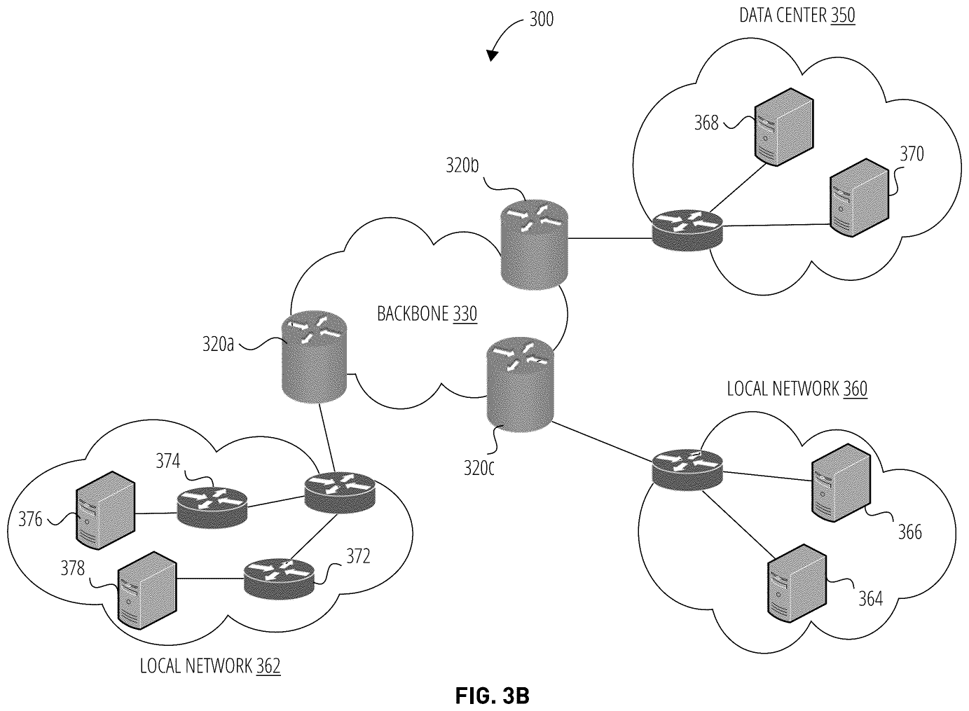

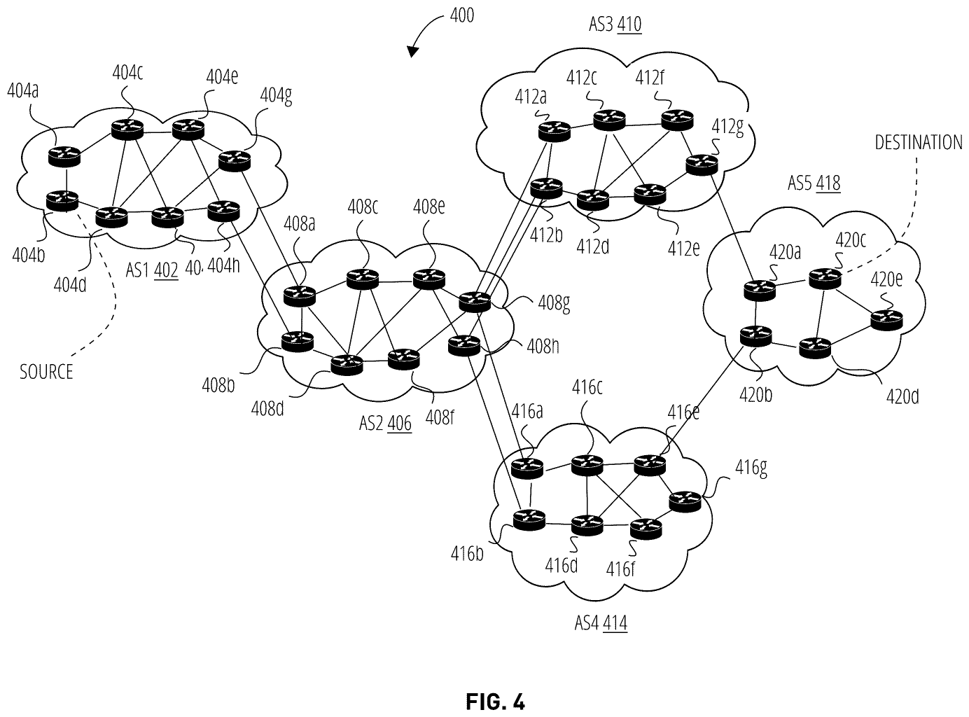

The system of routing data packets using trust scores is not limited to the networks matching the example illustrated in FIGS. 1A-1C. For example, the nodes can be different types of entities in a network, including but not limited to servers, switches, routers, bridges, gateways, hubs, leafs, spines, network interface cards (NICs), wireless access points, etc. FIG. 2 illustrates an example of a network that is a data center. FIG. 3A and FIG. 3B illustrate a range of network examples that include a backbone, physical edge routers, customer edge routers, and local networks. FIG. 4 illustrates an example of network 400 that routes data packets through respective autonomous systems (ASs). The methods and systems disclosed herein can be performed using these and other types of networks.

In general, the methods and systems disclosed herein can be performed in networks that include multiple nodes distributed within a topology that allows for different potential routes through the nodes of the network from a source to a destination. Often the nodes are geographically distributed across different locations. Further, the methods and systems disclosed herein can be performed to route a mix of sensitive and non-sensitive data traffic flowing through the network. The network will also include a component (e.g., and central controller in an AS, a WLAN controller, or another component) that performs a method to evaluate various parameters from the nodes (e.g., telemetry data) and assign dynamic trust scores to each node.

FIG. 2 illustrates a non-limiting example of a multi-tier data center 200, which includes data center access 202, data center aggregation 204, and data center core 206. The data center 200 provides computational power, storage, and applications that can support an enterprise business, for example.

The network design of the data center 200 can be based on a layered approach. The layered approach can provide improved scalability, performance, flexibility, resiliency, and maintenance. As shown in FIG. 2, the layers of the data center 200 can include the core, aggregation, and access layers (i.e., data center core 206, data center aggregation 204, and data center access 202).

The data center core 206 can include a processor 218. The data center core 206 layer provides the high-speed packet switching backplane for all flows going in and out of the data center 200. The data center core 206 can provide connectivity to multiple aggregation modules and provides a resilient Layer 3 routed fabric with no single point of failure. The data center core 206 can run an interior routing protocol, such as Open Shortest Path First (OSPF) or Enhanced Interior Gateway Routing Protocol (EIGRP), and load balances traffic between the campus core and aggregation layers using forwarding-based hashing algorithms, for example.

The data center aggregation 204 layer can provide functions such as service module integration, Layer 2 domain definitions, spanning tree processing, and default gateway redundancy. Server-to-server multi-tier traffic can flow through the aggregation layer and can use services, such as firewall and server load balancing, to optimize and secure applications. The smaller icons within the aggregation layer switch in FIG. 2 represent the integrated service modules. These modules provide services, such as content switching, firewall, SSL offload, intrusion detection, network analysis, and more.

The data center access 202 layer is where the servers physically attach to the network. The server components can be, e.g., 1RU servers, blade servers with integral switches, blade servers with pass-through cabling, clustered servers, and mainframes with OSA adapters The access layer network infrastructure can include modular switches, fixed configuration 1 or 2RU switches, and integral blade server switches. Switches provide both Layer 2 and Layer 3 topologies, fulfilling the various server broadcast domain or administrative requirements.

The architecture in FIG. 2 is an example of a multi-tier data center, but server cluster data centers can also be used. The multi-tier approach can include web, application, and database tiers of servers. The multi-tier model can use software that runs as separate processes on the same machine using inter-process communication (IPC), or the multi-tier model can use software that runs on different machines with communications over the network. In at least some examples, the following three tiers may be used: (i) Web-server; (ii) Application; and/or (iii) Database. Further, multi-tier server farms built with processes running on separate machines can provide improved resiliency and security. Resiliency is improved because a server can be taken out of service while the same function is still provided by another server belonging to the same application tier. Security is improved. For example, an attacker can compromise a web server without gaining access to the application or database servers. Web and application servers can coexist on a common physical server, but the database typically remains separate. Load balancing the network traffic among the tiers can provide resiliency, and security is achieved by placing firewalls between the tiers. Additionally, segregation between the tiers can be achieved by deploying a separate infrastructure composed of aggregation and access switches, or by using virtual local area networks (VLANs). Further, physical segregation can improve performance because each tier of servers is connected to dedicated hardware. The advantage of using logical segregation with VLANs is the reduced complexity of the server farm. The choice of physical segregation or logical segregation depends on your specific network performance requirements and traffic patterns.

The data center access 202 includes one or more access server clusters access server cluster 208, which can include layer 2 access with clustering and network interface controller (NIC) teaming. The access server clusters access server cluster 208 can be connected via gigabit ethernet (GigE) connections 210 to the workgroup switches workgroup switch 212. The access layer provides the physical level attachment to the server resources and operates in Layer 2 or Layer 3 modes for meeting particular server requirements such as NIC teaming, clustering, and broadcast containment.

The data center aggregation 204 can include aggregation processor 220, which is connected via 10 gigabit ethernet (10 GigE) connections 214 to the data center access 202 layer.

The aggregation layer can be responsible for aggregating the thousands of sessions leaving and entering the data center. The aggregation switches can support, e.g., many 10 GigE and GigE interconnects while providing a high-speed switching fabric with a high forwarding rate. The aggregation processor 220 can provide value-added services, such as server load balancing, firewalling, and SSL offloading to the servers across the access layer switches. The switches of the aggregation processor 220 can carry the workload of spanning tree processing and default gateway redundancy protocol processing.

For an enterprise data center, the data center aggregation 204 can contain at least one data center aggregation module that includes two switches (i.e., aggregation processors aggregation processor 220). The aggregation switch pairs work together to provide redundancy and to maintain the session state. For example, the platforms for the aggregation layer include the CISCO CATALYST 6509 and CISCO CATALYST 6513 switches equipped with SUP720 processor modules. The high switching rate, large switch fabric, and ability to support a large number of 10 GigE ports are important requirements in the aggregation layer. The aggregation processor 220 can also support security and application devices and services, including, e.g.: (i) Cisco Firewall Services Modules (FWSM); (ii) Cisco Application Control Engine (ACE); (iii) Intrusion Detection; (iv) Network Analysis Module (NAM); and/or (v) Distributed denial-of-service attack protection.

The data center core 206 provides a fabric for high-speed packet switching between multiple aggregation modules. This layer serves as the gateway to the campus core 216 where other modules connect, including, For example, the extranet, wide area network (WAN), and internet edge. Links connecting the data center core 206 can be terminated at Layer 3 and use 10 GigE interfaces to support a high level of throughput, performance, and to meet oversubscription levels. According to certain non-limiting examples, the data center core 206 is distinct from the campus core 216 layer, with different purposes and responsibilities. A data center core 206 is not necessarily required, but is recommended when multiple aggregation modules are used for scalability. Even when a small number of aggregation modules are used, it might be appropriate to use the campus core for connecting the data center fabric.

The data center core 206 layer can connect, e.g., to the campus core 216 and data center aggregation 204 layers using Layer 3-terminated 10 GigE links. Layer 3 links can be used to achieve bandwidth scalability, quick convergence, and to avoid path blocking or the risk of uncontrollable broadcast issues related to extending Layer 2 domains.

The traffic flow in the core can include sessions traveling between the campus core 216 and the aggregation processors 220. The data center core 206 aggregates the aggregation module traffic flows onto optimal paths to the campus core 216. Server-to-server traffic can remain within an aggregation processor 220, but backup and replication traffic can travel between the aggregation processors 220 by way of the data center core 206.

A computer network is a geographically distributed collection of nodes interconnected by communication links and segments for transporting data between end nodes, such as personal computers, cellular phones, workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical light paths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to forward data from one network to another.

FIG. 2 is a schematic block diagram of a non-limiting example of a computer network 300 that includes various nodes/devices, such as a plurality of routers/devices interconnected by links or networks. For example, customer edge (CE) routers 310 may be interconnected with provider edge (PE) routers (e.g., PE-1 320a, PE-2 320b, and PE-3 320c) to communicate across a core network, such as an illustrative network backbone 330. For example, the routers (e.g., CEs, PEs) may be interconnected by the public Internet, a multiprotocol label switching (MPLS), or a virtual private network (VPN). Data packets 340 (e.g., traffic/messages) may be exchanged among the nodes/devices of the computer network 300 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN utilizing a Service Provider network, via one or more links exhibiting very different network and service level agreement characteristics.

According to certain non-limiting examples, a given customer site may fall under one or more of the following categories:
1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2.) Site Type B: a site connected to the network using two MPLS VPN links (e.g., from different Service Providers) using a single CE router, with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 320b and a second CE router 110 connected to PE-3 320c.

FIG. 3B illustrates an example of computer network 300 in greater detail, according to various embodiments. As shown, network backbone 330 may provide connectivity between devices located in different geographical areas and/or different types of local networks. For example, network 100 may comprise local/branch networks 360 and 362 that include devices/nodes 372, 374, 376, and 378 and devices/nodes 364 and 366, respectively, as well as a data center/cloud environment 350 that includes servers 368 and 370. Notably, local network 360, local network 362, and data center 350 can be located in different geographic locations.

Server 368 and server 370 can include, in various embodiments, a network management server (NMS), a dynamic host configuration protocol (DHCP) server, a constrained application protocol (CoAP) server, an outage management system (OMS), an application policy infrastructure controller (APIC), an application server, etc. Network 100 may include any number of local networks, data centers, cloud environments, devices/nodes, servers, etc.

In some embodiments, the techniques herein may be applied to other network topologies and configurations. For example, the techniques herein may be applied to pecring points with high-speed links, data centers, etc.

In various embodiments, computer network 300 may include one or more mesh networks, such as an Internet of Things network. Loosely, the term “Internet of Things” or “IoT” refers to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Notably, shared-media mesh networks, such as wireless or PLC networks, etc., are often deployed on what are referred to as Low-Power and Lossy Networks (LLNs), which are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen to thousands or even millions of LLN routers, and support point-to-point traffic (between devices inside the LLN), point-to-multipoint traffic (from a central control point such at the root node to a subset of devices inside the LLN), and multipoint-to-point traffic (from devices inside the LLN towards a central control point). Often, an IoT network is implemented with an LLN-like architecture. For example, as shown, local network 360 may be an LLN in which CE-2 operates as a root node for devices/nodes 10-16 in the local mesh, in some embodiments.

In contrast to traditional networks, LLNs face a number of communication challenges. First, LLNs communicate over a physical medium that is strongly affected by environmental conditions that change over time. Some examples include temporal changes in interference (e.g., other wireless networks or electrical appliances), physical obstructions (e.g., doors opening/closing, seasonal changes such as the foliage density of trees, etc.), and propagation characteristics of the physical media (e.g., temperature or humidity changes, etc.). The time scales of such temporal changes can range between milliseconds (e.g., transmissions from other transceivers) to months (e.g., seasonal changes of an outdoor environment). In addition, LLN devices typically use low-cost and low-power designs that limit the capabilities of their transceivers. In particular, LLN transceivers typically provide low throughput. Furthermore, LLN transceivers typically support limited link margin, making the effects of interference and environmental changes visible to link and network protocols. The high number of nodes in LLNs in comparison to traditional networks also makes routing, quality of service (QOS), security, network management, and traffic engineering extremely challenging, to mention a few.

FIG. 4 illustrates a non-limiting example of a network 400 that includes four autonomous systems (i.e., AS1 402, AS2 406, AS3 410, AS4 414, and AS5 418). The network 400 is configured to take into account for the trustworthiness of the nodes, as represented by a trust score, when considering routing decisions. For example, trust score can be generated for each of the nodes. These trust scores can also be referred to as a node-level trust score to distinguish from the cumulative trust score for a path or the AS-level trust score, which are discussed below. The trust scores allow routing decisions to be based, at least partly, on selecting nodes that preserve the data integrity and stably and/or timely transmit the data flows with consistency (e.g., avoids compromised or flaky nodes in the routing path).

In the non-limiting example illustrated in FIG. 2, AS1 402 includes eight nodes (i.e., node1 404a, node2 404b, node3 404c, node4 404d, node5 404c, node6 404f, node7 404g, and node8 404h). AS2 406 includes eight nodes (i.e., node1 408a, node2 408b, node3 408c, node4 408d, node5 408e, node6 408f, node7 408g, and node8 408h). AS3 410 includes seven nodes (i.e., node1 412a, node2 412b, node3 412c, node4 412d, node5 412e, node6 412f, and node7 412g). AS4 414 includes eight nodes (i.e., node1 416a, node2 416b, node3 416c, node4 416d, node5 416e, node6 416f, and node7 416g). AS5 418 includes five nodes: node1 420a, node2 420b, node 3 420c, node4 420d, and node5 420c.

According to certain non-limiting examples, AS1 30 and AS3 410 are Multiprotocol Label Switching (MPLS) networks without a central controller, and AS2 406, AS4 414, and AS5 418 are networks that each have a Segment Routing Path Computation Element (SR-PCE) controller.

According to certain non-limiting examples, using network 400, trustworthiness within internet protocol (IP) networking can be realized by constructing, deploying, and maintaining network structures and services that make routing decisions that account for the trustworthiness of the routing path and the trustworthiness of the nodes therein. This can be realized, for example, by improving the existing Interior Gateway Protocol (IGP) and Border Gateway Protocol (BGP) protocols to support trusted path selection that considers the trustworthiness of the nodes. As used herein the term “trust” means that a given node is believed to behave reliably as desired and is free from cybersecurity vulnerabilities and malicious activity.

Accordingly, the methods and systems disclosed herein provide, among other things, enhancements for both IGP and BGP protocols to support end-to-end trustworthy path selection. This can be achieved in various ways and in various types of systems. For example, the trust score can be used for intra-AS routing in either an Autonomous System (AS) with a central controller or an AS without a central controller. Further, for inter-AS communications, the trust score can assist in selecting the optimal trust worthy route from one AS to a neighboring AS, and, when choosing among ASs for a routing path, the trust score can be used to determine which AS is more trustworthy.

According to certain non-limiting examples, the disclosed methods and systems use the trust scores to achieve more trustworthy network routing using an AS with a central controller (e.g., a central controller such as Segment Routing Path Computation Element (SR-PCE)). An AS with a central controller can have several paths from the source node to the destination node. When determining the most trustworthy path, the methods and systems disclosed herein can use the trust score to provide improvements to the current Interior Gateway Protocol (IGP) routing protocols (e.g., Open Shortest Path First (OSPF), Intermediate System to Intermediate System (IS-IS), or Dijkstra's algorithm) to account for trustworthy links or nodes.

According to certain non-limiting examples, the disclosed methods and systems can use the trust scores to achieve more trustworthy network routing in an AS that has a central controller. In this case, there may be several paths from the source to the destination. Without access to a metric such as the trust score, the Provider Edge (PE) cannot decipher which of the links and/or nodes are trustworthy when determining the traffic path and fails to provide the most trustworthy path.

According to certain non-limiting examples, the disclosed methods and systems use the trust scores to achieve more trustworthy network routing for inter-AS communications. For example, consider the nodes at the boundaries of two neighboring ASs. When determining which link is used for inter-AS communications, there may be many candidate links between respective nodes of the first AS to corresponding nodes of the second AS. Selecting a link with a low value for the trust score of the nodes at both the first AS and the second AS can provide trustworthiness. That is, the trust score can be used in selecting the optimal trustworthy nodes connecting neighboring ASs to facilitate inter-AS communications.

Further, for inter-AS communications, the process of selecting ASs along which to route network traffic can be improved by using the trust score. For example, a less trustworthy AS can be avoided in favor of a more trustworthy AS to provide a more trustworthy path.

Generally to all methods and systems disclosed herein, a trust score is determined for the respective nodes based on the indicia of trustworthiness associated with the respective nodes (e.g., telemetry data from the nodes).

For example, in an AS with SR-PCE, a Path Computation Element Protocol (PCEP) can be performed between the path computation element (PCE) and the path computation client (PCC). The PCEP functionality is extended to convey the indicia of trustworthiness associated with the respective nodes. The indicia of trustworthiness are then combined to form a trust score.

According to certain non-limiting examples, the nodes send data (e.g., telemetry data) to network 400, and one or more processors in network 100 apply the data to a trust-scoring model (e.g., a machine learning (ML) model) that evaluates this data and assigns trust scores to each of the nodes. For example, in a network that is executing a gateway protocol (e.g., the border gateway protocol (BGP) or an interior gateway protocol (IGP)), the data can be sent to a central controller such as Segment Routing Path Computation Element (SR-PCE), which applies the data to the trust-scoring model to thereby assign the trust scores. For example, when determining the preferred path(s) (e.g., the optimal-trustworthy paths), the methods and systems disclosed herein can use the trust score to provide improvements to the current Interior Gateway Protocol (IGP) routing protocols (e.g., Open Shortest Path First (OSPF), Intermediate System to Intermediate System (IS-IS), or Dijkstra's algorithm) to account for which nodes trustworthy, load balancing, and minimizing hop count, e.g., while selecting the routing path.

Additionally or alternatively, the trust scores can be used in modified versions of the BGP and external BGP (cBGP). For example, the eBGP protocol can be modified to account for the trust score of the exit nodes. Often, inter-AS (autonomous system) communication is performed using eBGP. The methods and systems disclosed herein modify the BGP protocol to improve the selection of the exit node and the link to a neighboring AS based on the trust score. For example, the BGP can be modified to include a path attribute to encode the trust score, and this path attribute is optional transitive. According to certain non-limiting examples, the values for the trust score are encoded in the newly defined BGP path attribute and it will be exchanged between the Autonomous System Border Router (ASBR) in the BGP update messages.

According to certain non-limiting examples, an AS-level trust score can also be calculated for the autonomous system (AS) as a whole, to aggregate the information from the trust scores of the individual nodes in the AS. For example, the AS-level trust scores can be calculated based on the number of trustworthy nodes and links inside the AS. Determining trustworthy nodes can be based on whether a given node falls in a trustworthiness range (e.g., has a trust score below a predefined trustworthiness threshold). That is, determining whether a node is trustworthy can be a binary determination by comparing the trust score of the node to a trust-score threshold. The AS-level trust score can be used to select the upstream AS, so long as the AS path length is the same in the AS_PATH attribute.

According to certain non-limiting examples that include an SR-PCE network, the PCE can calculate the trust score because the PCE has access to the telemetry data, for example. Thus, the PCE can push the trust score to the path computation clients (PCCs) corresponding to the respective nodes (e.g., the ASBRs) via the PCEP. Once the ASBRs receive the trust score it will be exchanged via BGP update messages. In a traditional MPLS network without a central controller, the trust score can be configured and/or assigned manually, for example. For Inter-AS communications, the preferred exit point from the AS can then be selected as the exit node having the lower trust score and providing load balancing.

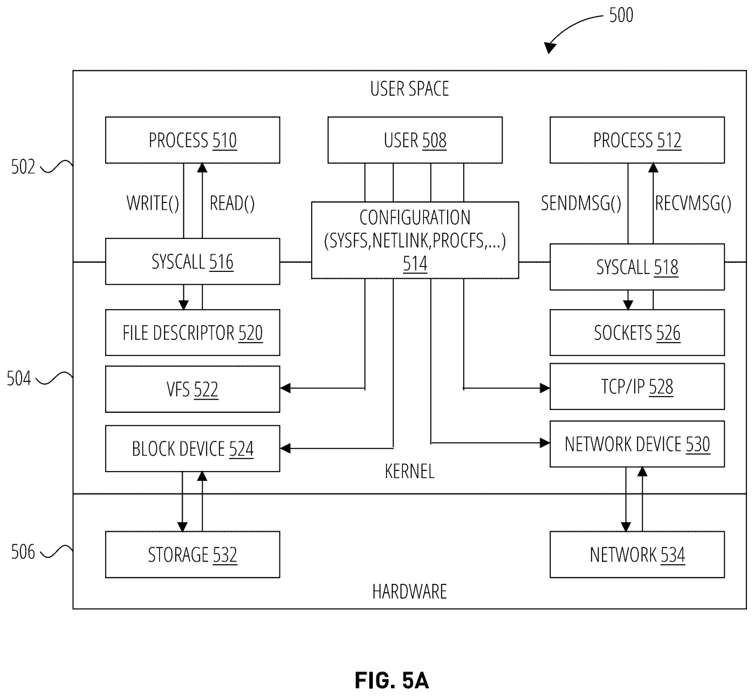

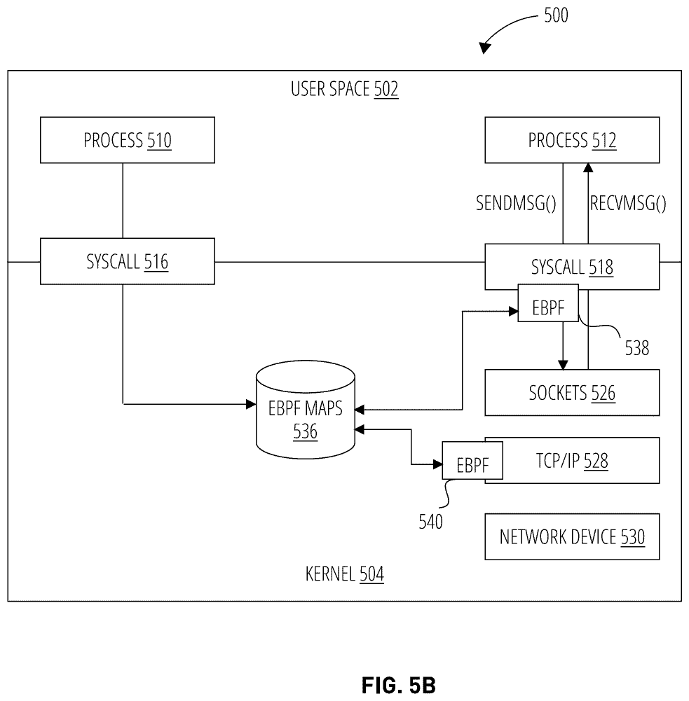

FIG. 5A illustrates a non-limiting example of implementing extended Berkley pack filters (eBPF). The eBPF architecture 500 can be implemented on a central processing unit (CPU and includes a user space 502, Kernel 504, and hardware 506. For example, the user space 502 can be a place where regular applications run, whereas the kernel 504 is where most operating system-related processes run. An eBPF in a processor at a node (e.g., a server or router) of the network can be used to generate network data including program traces and data the types of system calls to the kernel 504. This network data can be used to determine when the node is behaving anomalously, and therefore can be used to determine the trust score for the node.

The kernel 504 can have direct and full access to the hardware 506. When a given application in user space 502 connects to hardware 506, the application can do so via calling APIs in kernel 504. Separating the application and the hardware 506 can provide security benefits. An eBPF can allow user-space applications to package the logic to be executed in the kernel 504 without changing the kernel code or reloading.

Since eBPF programs run in the kernel 504, the eBPF programs can have visibility across all processes and applications, and, therefore, they can be used for many things: network performance, security, tracing, and firewalls.

The user space 502 can include a process 510, a user 508, and process 512. The kernel 504 can include a 520, a virtual file system (VFS) 522, a block device 524, sockets 526, a TCP/IP 528, and a network device 530. The hardware 506 can include storage 532 and network 534.

eBPF programs are event-driven and are run when the kernel or an application passes a certain hook point. Pre-defined hooks include system calls, function entry/exit, kernel tracepoints, network events, and several others. If a predefined hook does not exist for a particular need, it is possible to create a kernel probe (kprobe) or user probe (uprobe) to attach cBPF programs almost anywhere in kernel or user applications. When the desired hook has been identified, the eBPF program can be loaded into the kernel 504 using the bpf system call (e.g., syscall 516 or 518). This is typically done using one of the available eBPF libraries. The next section provides an introduction into the available development toolchains. Verification of the cBPF program ensures that the eBPF program is safe to run. It validates that the program meets several conditions (e.g., the conditions can be that the process loading the e BPF program holds the required capabilities/privileges; the program does not crash or otherwise harm the system; and the program always runs to completion).

A benefit of the kernel 504 is abstracting the hardware (or virtual hardware) and providing a consistent API (system calls) allowing for applications to run and share the resources. To achieve this, a wide set of subsystems and layers are maintained to distribute these responsibilities. Each subsystem can allow for some level of configuration 514 to account for different needs of users. When a desired behavior cannot be configured, the kernel 504 can be modified to perform the desired behavior. This modification can be realized in three different ways: (1) by changing kernel source code, which may take a long time (e.g., several years) before a new kernel version becomes available with the desired functionality; (2) writing a kernel module, which may require regular editing (e.g., every kernel release) and incurs the added risk of corrupting the kernel 504 due to lack of security boundaries; or (3) writing an eBPF program that realizes the desired functionality. Beneficially, eBPF allows for reprogramming the behavior of the kernel 504 without requiring changes to kernel source code or loading a kernel module.

Many types of eBPF programs can be used, including socket filters and system call filters, networking, and tracing. Socket filter type eBPF programs can be used for network traffic filtering, and can be used for discarding or trimming of packets based on the return value. XDP type eBPF programs can be used to improve packet processing performance by providing a hook closer to the hardware (at the driver level), e.g., to access a packet before the operative system creates metadata. Tracepoint type eBPF programs can be used instrument kernel code, e.g., by attaching an eBPF program when a “perf” event is opened with a command “perf_event_open(2)”, then use the command “ioctl(2)” to return a file descriptor that can be used to enable the associated individual event or event group and to attach the eBPF program to the tracepoint event. Helper type eBPF programs can be used to determines which subset of in kernel functions can be called. Helper functions are called from within eBPF programs to interact with the system, to operate on the data passed as context, or to interact with maps.

FIG. 5B illustrates just-in-time (JIT) compilation of cBPF programs. JIT compilation translates the generic bytecode of the program into the machine specific instruction set to optimize execution speed of the program. This makes eBPF programs run as efficiently as natively compiled kernel code or as code loaded as a kernel module.

An aspect of eBPF programs is the ability to share collected information and to store state information. For example, eBPF programs can leverage eBPF maps 536 to store and retrieve data in a wide set of data structures. The eBPF maps 536 can be accessed from eBPF program 538 and cBPF program 540 as well as from applications (e.g., process 510 and process 512) in user space 502 via a system call (e.g., syscall 516 and syscall 518). Non-limiting examples of supported map types include, e.g., hash tables, arrays, least recently used (LRU), ring buffer, stack trace, and longest prefix match (LPM), which illustrates the diversity of data structures supported by eBPF programs.

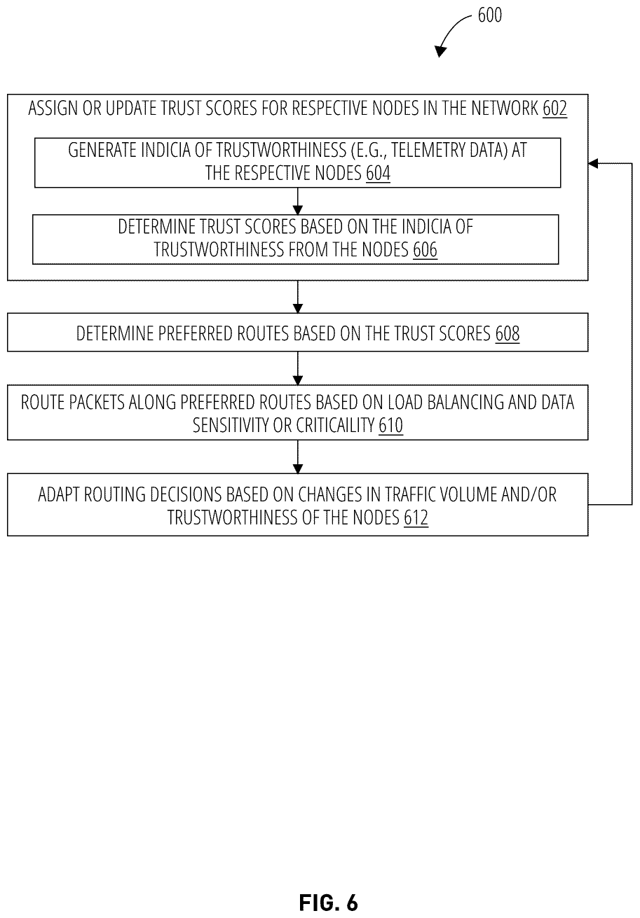

FIG. 6 illustrates an example of method 600 for assigning and using trust scores to route data traffic along paths through the network that include trustworthy, secure, and reliable nodes. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements method 600 may perform functions at substantially the same time or in a specific sequence.

According to some examples, in process 602, method 600 includes assigning or updating trust scores for respective nodes in the network. Process 602 can include step 604 and step 606. In step 604, network data (e.g., telemetry data) generated at the respective nodes provide indicia of trustworthiness. For example, the network data can be sent to one or more processors, and then in step 606, trust scores are determined for the respective nodes based on the network data.

According to certain non-limiting examples, the network data used to determine the trust scores in collected from traffic telemetry from the nodes within the network. Then the network data (e.g., the traffic telemetry) is applied to a machine learning (ML) model to determine a trust score representing, for each of the respective nodes, a reliability of data packets securely being sent through the node.

According to certain non-limiting examples, assigning the trust scores can include assigning confidence scores corresponding to the respective trust scores. For example, the confidence scores can include/depend on a standard deviation related to the trust score, a sample size, or the diversity of the types of the network data.

According to certain non-limiting examples, training the ML model can include a learning phase and an application phase. In the learning phase, the nascent trust scores are used for routing decisions in an exploration mode to gather more information about the behaviors of the respective nodes. In the application phase, the mature trust scores are used for routing decisions. For example, the trust scores can be used in an exploitation mode to restrict/limit data traffic routed through paths that include a subset of nodes having lower trust scores than other potential routes. For example, assigning the trust scores to respective nodes within the network can include receiving, at one or more processors, network data representing indicia of trustworthiness at the respective nodes of the network, and applying the network data to the machine learning (ML) model to determine the trust scores. While the ML model is operating it can continuously undergo reinforcement learning, such that early on the trust scores from the ML model are nascent and immature because the model is not yet converged to determining accurate trust scores. Thus, the ML model is initially operated in a learning phase and the later switches over to an application phase. In the learning phase, the trust scores are nascent trust scores that are used for routing decisions in an exploration mode to explore a trust landscape and gather more information regarding what aspects of the network data represent trustworthiness of the respective nodes. In the application phase, the trust scores are mature trust scores that are used for routing decisions in an exploitation mode to direct traffic flows along routes that are determined to be most trustworthy based on the trust scores.

According to certain non-limiting examples, the machine learning (ML) model can include a decision tree model, a regression model, a classifier models, a clustering model, a K-means clustering model, a K-nearest neighbor clustering model, a Q-learning model, a large language model, or a transformer model. Further, supervised learning or unsupervised learning to train the ML models. For example, the ML model can include using supervised learning for decision trees or random forests. Here, decision trees can be used to assign trust scores to nodes based on a variety of input parameters like connection stability, frequency of activity, and past behavior. The tree can be trained on a labeled dataset where the labels indicate the trustworthiness of historical nodes. As another non-limiting example, the ML model can include using unsupervised learning for K-means clustering. Here, K-means clustering can be used to group nodes based on similar characteristics. Each cluster can then be assigned a trust score based on the collective behavior of its nodes. This unsupervised method is useful when pre-labeled data are not readily available. Additionally or alternatively, K-nearest neighbor clustering can be used to group nodes based on similar characteristics. As a third non-limiting example, the ML model can include using reinforcement learning for Q-Learning. In Q-Learning, an agent learns to take actions-like routing traffic-based on the rewards it receives for those actions. Q-Learning can be used to implement load balancing, where the rewards are based on maintaining optimal network performance. As a fourth non-limiting example, the ML model can include using generative adversarial networks (GANs) to determine the trust scores. For example, GANs can be used to generate new instances based on learned data, while the discriminative model would evaluate these instances and assign trust scores. Additionally or alternatively, large language models (LLMs) can be used to analyze log files or textual data from nodes for anomaly detection. Unusual patterns or changes in the log files might indicate potential issues or threats, which could affect a node's trust score. These ML models can be combined, e.g., by using the LLM to detect anomalous behavior data which is combined with other data (e.g., packet latency and telemetry data from the node) as in input to another ML model (e.g., a classifier or decision tree model) that then generates the trust score.

According to certain non-limiting examples, the network data used for determining the trust scores for the nodes can include: (i) telemetry data from the given node; (ii) packet latency through the given node; (iii) packet loss rate at the given node; (iv) results of deep packet inspection at the given node; (v) a number of successful transactions the given node; (vi) response time of the given node; (vii) incidence of security breaches or data leak at the given node; (viii) a software version installed on the given node; (ix) security patches installed on the given node; (x) detections of potential security threats, vulnerabilities, bugs, or attacks; exposures to other nodes suspected of compromise; (xi) number of connections to neighboring nodes; (xii) time of operating in a proper manner; (xiii) network policies at the given node; (xiv) statistical fluctuations in performance at the given node; and/or (xv) anomalous events detected at the given node.

For example, the network data can include packet latency through the given node, outbound calls from the given node, changes to behavior (e.g., anomalous behavior) on the given node), analysis of behavioral graphs that represent node/program behavior that is represented in log files or program traces, detection of malicious signatures, and records of current version of firmware/software operating on the given node. An example of anomalous behavior on a given node might be conditioned on prior observations of the given node (and similar nodes) over a period, such that based on these prior observations, e.g., it is not expected that port 8080 be open or a program trace from the eBPF indicates that an unusual series of system calls are made to the kernel space. An example of a record of the current version of firmware/software operating on the given node can be, e.g., information of: (i) whether the node is executing routing software that has been upgraded to the latest version, (ii) whether the node includes all relevant security patches, (iii) a list of current network policies for the node, and/or (iv) a Software Bill of Materials (SBOM) for the node.

According to certain non-limiting examples, the ML model is trained to associate different locations within the network with respective likelihoods of being trustworthy. For example, a location deeper in a data center network (e.g., data center 200) can be more protected and more trustworthy because data packets will have passed through more firewalls and security screening/filtering and policy protections. For example, the network can be partitioned into trust zones, such that certain zones are associated with different degrees of trustworthiness. Examples, of zones within a network can include the respective layers illustrated in FIG. 2 or the backbone 330, the data center 350, and the local network 360 illustrated in FIG. 3B. Further, autonomous systems (AS) in BGP and MLPS networks illustrated in FIG. 4 can be examples of localized regions (i.e., zones) that can be associated with different degrees of trustworthiness.

According to certain non-limiting examples, the ML model is trained to discriminate which nodes are exhibiting anomalous behaviors and/or which nodes are behaving erratically, and the trust scores of such nodes are adjusted to indicate less trustworthiness.

According to certain non-limiting examples, the trust scores can be generated or updated based on telemetry data representing performance metrics. For example, the performance metrics can be defined to evaluate the performance of the system, such as average latency, packet loss rate, number of successful transactions, server response time, and incidence of security breaches or data leaks.

According to some examples, in step 608, preferred routes can be determined based on the trust scores.

According to certain non-limiting examples, for a set of potential routes from an origination node to a destination node, an optimal route can be determined based on the trust scores of the respective nodes in each of the potential routes. Further, an objective function can be calculated, wherein the value of the objective function for a given potential route is based on the trust scores of the respective nodes of the given potential routes. Thus, the optimal route can be determined by finding the lowest value of the objective function for a set of potential routes.

According to certain non-limiting examples, preferred routes can be determined based on the trust scores based on a degree of data sensitivity of the one or more data packets. For example, load balancing can achieved by routing a first traffic flow of the one or more data packets along a first route, wherein the first traffic flow has a higher degree of the data sensitivity than a second traffic flow. Further, load balancing can achieved by routing a part of the second traffic flow along a second route that is less trustworthy than the first route, when a packet routing capacity of the first route is exceeded by a combination of the first traffic flow and the second traffic flow.

According to certain non-limiting examples, preferred routes can be determined based on the trust scores by optimizing an objective function that includes a trust term and a load balancing term. The objective function represents scores indicating the merit of the potential routes (e.g., a lower value of the objective function indicates a more preferred route). The trust term for a potential route combines the trust scores of the nodes along the potential route into the cumulative metric. The load balancing term accounts for bottlenecks and limitations arising from the traffic-flow capacities of the potential route. For example, the cumulative metric can be the above-discussed cumulative trust score (CTS), which is expressed as an L^{p}-norm of the trust scores of the nodes along the potential route. Further, the respective terms of the objective function can a weighted combination. According to certain non-limiting examples, the objective function is a weighted sum of the respective terms (e.g., the trust term, the load-balancing term, etc.) According to certain non-limiting examples, the weights for the weighted combination are based on a degree of data sensitivity and/or data criticality of the one or more data packets.

According to certain non-limiting examples, the preferred routes are determined piecewise using preferred route segments within different regions and then stitching these together. For example, for each local region of the network, one or more preferred route segments can be determined through a local region of the network. Then, the preferred route segment(s) from one of the local regions can be stitched together with the preferred route segment(s) from other local regions to form the preferred routes. For example, autonomous systems (AS) in BGP and MLPS networks are localized regions, and the preferred route segments can be determined for respective ASs, such that a preferred route can be formed by stitching together the preferred route segments of the respective ASs.

Additionally or alternatively, the piecewise nature of the preferred routes can arise from the properties of using Graph Convolutional Networks (GCN) or Graph Neural Networks (GNN) in an ML model used to determine the trust scores and/or the routes. For example, the information of the trust scores can be locally diffused to neighboring nodes and then next nearest neighbor nodes, and so forth, using a convolutional/diffusion information sharing mechanism. Thus, in a distributed manner, routing decisions can be made using the local information of trust scores for a given neighborhood. For example, the trust scores can be locally diffused to neighbor nodes and next-nearest neighbor nodes using fractal information sharing via Graph Convolutional Networks (GCN) or Graph Neural Networks (GNN), and a degree of diffusion can correspond to a number in layers in the first ML model.

According to certain non-limiting examples, the trust scores can be partitioned into respective ranges, and different actions can be applied to the nodes depending on which range the fall in. For example, a trust score of a node can be determined to be within one of three ranges. That is, the trust score can fall within a first range of values, a second range of values, or a third range of values. When the trust score of the node is within the first range of values, the node can be treated as compromised, e.g., by quarantining the node. When the trust score of the node is within the first range of values, the node can be treated as suspicious, e.g., by adding observability functions to the node that provide additional information regarding potential problems on the node. When the trust score of the node is within the first range of values, the node can be treated as normal by, e.g., continuing to monitor the network data from the node and updating a value of the trust score of the node based on the network data. Further, when the trust score of the node is within the first range of values, the node can remain quarantined until remediating action is applied to the node to address a detected problem, the remediating action comprising additional testing of the node in a sandbox, scanning the node to detect and eradicate malicious software, or applying one or more security patches or policies that are responsive to the detected problem.

According to certain non-limiting examples, the network can include a functionality to simulate various security threat scenarios, like malicious node behavior or sudden increase in suspicious activity. These simulations can be used to determine and distinguish the type of network and telemetry data resulting from malicious activity as compared to normal activity in the network. Further, these simulations can be used to evaluate determine a security threat resulting from an increases in malicious node behavior or sudden increase in suspicious activity.

According to some examples, in step 610, data packets and data flows can be routed along preferred routes. The amounts of the data flows directed along which preferred routes can be based on load balancing. Further, which data packets are directed along which preferred routes can depend on the data sensitivity and/or data criticality of the respective packets.

According to certain non-limiting examples, the network can include a functionality to manipulate the volume, type, and destination of data traffic in the network.

According to certain non-limiting examples, after determining the preferred routes based on the trust scores, when traffic volume is low, traffic flow is predominantly or entirely through a most preferred route. When traffic volume is medium, traffic flow is routed through the most preferred route up to its flow capacity, and excess traffic flow above the flow capacity of the most preferred route is routed through the second most preferred route. When traffic volume is high, traffic flow is routed through the most preferred route up to its flow capacity, and excess traffic flow above the flow capacity of the most preferred route is routed through the second most preferred route up to its flow capacity, with remaining data flow being routed through additional preferred routes.

According to certain non-limiting examples, tis a mix of sensitive and non-sensitive data traffic flowing through the network. For example, a first traffic flow can have a higher degree of the data sensitivity than a second traffic flow. This diversity of sensitivity among the data flows can be addressed by routing the first traffic flow along the most preferred route. Here, the most preferred route has the lowest cumulative trust score, for example. The second traffic flow can then be sent along the second most preferred route. If the entire flow capacity of the most preferred route is not saturated by the first data flow, then a part of the second traffic flow can be routed along the most preferred route up to the limit of its flow capacity, and the remainder of the second traffic flow can be routed along the second most preferred route. That is, the most sensitive (or critical) data is routed on the most trusted routes, and load balancing is achieved by sending less sensitive data along the next most trusted routes.

According to certain non-limiting examples, in addition to trust and load balancing, other factors can be considered in routing decision, including, e.g., hop count, negotiated fees for using nodes in a visitor network, environmental factors, stability, etc.

According to some examples, the method includes adapting routing decisions based on changes in traffic volume and/or trustworthiness of the nodes at step 612. For example, as the traffic volume increases or decreases, the routing decisions can dynamically evolve. Further, as additional network data is received the values of the trust scores can change, and the routing decisions can dynamically evolve.

According to certain non-limiting examples, reinforcement learning can be applied to train the network. For example, suspicions of anomalous behavior can be reported to a security operations center (SOC) where it is reviewed and feedback is generated either confirming or denying the suspicions (e.g., indicating that reported behavior at the node of the network is a false positive or a true positive for being a security concern/event). Thus, the suspicions of anomalous behavior together with the feedback provide labeled training data for reinforcement learning.

According to certain non-limiting examples, feedback from an SOC can be used to continuously train the first ML model to recognize indicia of untrustworthiness in the network data. This reinforcement learning can include detecting and signaling portions of the network data corresponding to anomalous behaviors. The processor that is training the ML model can receive the feedback from the SOC and use it to label the portions of the network data that are indicated as corresponding to anomalous behaviors. That is, the portions of the network data can have labels of “true positive” or “false positive” affixed to generate reinforcement training data. Then reinforcement training can be performed on the first ML model using the reinforcement training data.

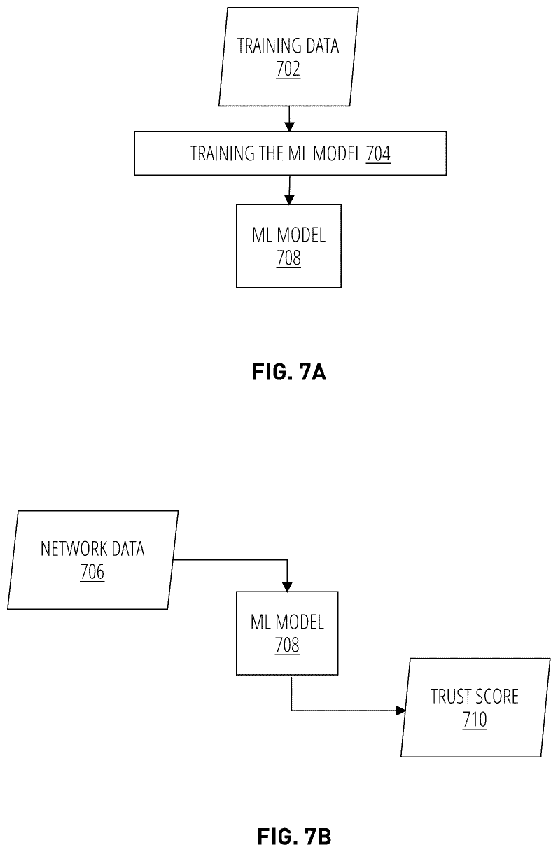

FIG. 7A illustrates an example of training an ML model 708 that can be used for determining trust scores of the nodes in a network. In step 704, training data 702 (e.g., network data, program traces, log files, data flow statistics through the network, packet latencies, rates for dropped packets, etc.) is applied to train the ML model 708. For example, the ML model 708 can be an artificial neural network (ANN) that is trained via supervised or unsupervised learning using a backpropagation technique to train the weighting parameters between nodes within respective layers of the ANN.

In supervised learning, the training data 702 is applied as an input to the ML model 708, and an error/loss function is generated by comparing the output from the ML model 708 with the desired output (e.g., labels of trustworthy or untrustworthy or human-determined trust scores can be associated with portions of network data in the training data 702). The coefficients of the ML model 708 are iteratively updated to reduce an error/loss function. The value of the error/loss function decreases as outputs from the ML model 708 increasingly approximate the desired output. In other words, ANN infers the mapping implied by the training data, and the error/loss function produces an error value related to the mismatch between the desired output and the outputs from the ML model 708 that are produced as a result of applying the training data 702 to the ML model 708.

Alternatively, for unsupervised learning or semi-supervised learning, training data 702 is applied to train the ML model 708. For example, the ML model 708 can be an artificial neural network (ANN) that is trained via unsupervised or self-supervised learning using a backpropagation technique to train the weighting parameters between nodes within respective layers of the ANN.

In unsupervised learning, the training data 702 is applied as an input to the ML model 708, and an error/loss function is generated by comparing the predictions of the next program event in a sequence of events from the ML model 708 with the actual next event in the event sequence. The coefficients of the ML model 708 can be iteratively updated to reduce an error/loss function. The value of the error/loss function decreases as outputs from the ML model 708 increasingly approximate the training data 702.

For example, in certain implementations, the cost function can use the mean-squared error to minimize the average squared error. In the case of a multilayer perceptrons (MLP) neural network, the backpropagation algorithm can be used for training the network by minimizing the mean-squared-error-based cost function using a gradient descent method.

Training a neural network model essentially means selecting one model from the set of allowed models (or, in a Bayesian framework, determining a distribution over the set of allowed models) that minimizes the cost criterion (i.e., the error value calculated using the error/loss function). Generally, the ANN can be trained using any of numerous algorithms for training neural network models (e.g., by applying optimization theory and statistical estimation).

For example, the optimization method used in training artificial neural networks can use some form of gradient descent, using backpropagation to compute the actual gradients. This is done by taking the derivative of the cost function with respect to the network parameters and then changing those parameters in a gradient-related direction. The backpropagation training algorithm can be: a steepest descent method (e.g., with variable learning rate, with variable learning rate and momentum, and resilient backpropagation), a quasi-Newton method (e.g., Broyden-Fletcher-Goldfarb-Shannon, one step secant, and Levenberg-Marquardt), or a conjugate gradient method (e.g., Fletcher-Reeves update, Polak-Ribiére update, Powell-Beale restart, and scaled conjugate gradient). Additionally, evolutionary methods, such as gene expression programming, simulated annealing, expectation-maximization, non-parametric methods and particle swarm optimization, can also be used for training the ML model 708.

The training step 704 for training the ML model 708 can also include various techniques to prevent overfitting to the training data 702 and for validating the trained ML model 708. For example, bootstrapping and random sampling of the training data 702 can be used during training.

Further, other machine learning (ML) algorithms can be used for the ML model 708, and the ML model 708 is not limited to being an ANN. For example, there are many machine-learning models, and the ML model 708 can be based on machine-learning systems that include generative adversarial networks (GANs) that are trained, For example, using pairs of network measurements and their corresponding optimized configurations.

As understood by those of skill in the art, machine-learning based classification techniques can vary depending on the desired implementation. For example, machine-learning classification schemes can utilize one or more of the following, alone or in combination: hidden Markov models, recurrent neural networks (RNNs), convolutional neural networks (CNNs); Deep Learning networks, Bayesian symbolic methods, general adversarial networks (GANs), support vector machines, image registration methods, and/or applicable rule-based systems. Where regression algorithms are used, they can include but are not limited to: a Stochastic Gradient Descent Regressors, and/or Passive Aggressive Regressors, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

For example, ML model 708 can be a transformer neural network that uses a sequence of events to predict the next event generated by a program. The ML model 708 can use a transformer architecture such as a Bidirectional Encoder Representations from Transformer (BERT) and a Generative Pre-trained Transformer (GPT). The transformer architecture can use an input embedding block to provide representations for event sequences of network data. According to certain non-limiting examples, the representation is a real-valued vector that encodes the meaning of the word in such a way that words that are closer in the vector space are expected to be related events. Event embeddings can be obtained using modeling and feature learning techniques, where event sequences of the network data are mapped to vectors of real numbers. According to certain non-limiting examples, the input embedding block can be learned embeddings to convert the input tokens and output tokens to vectors that have the same dimension as the positional encodings, for example.

The positional encodings provide information about the relative or absolute position of the tokens in the sequence. According to certain non-limiting examples, the positional encodings can be provided by adding positional encodings to the input embeddings at the inputs to the encoder 7 and decoder. The positional encodings have the same dimension as the embeddings, thereby enabling a summing of the embeddings with the positional encodings. There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that so doing allows the model to extrapolate to sequence lengths longer than the ones encountered during training.

The encoder uses stacked self-attention and point-wise, fully connected layers. The encoder can be a stack of N identical layers (e.g., N=6), and each layer is an encode block, as illustrated by encode block. Each encode block can have two sub-layers: (i) a first sub-layer has a multi-head attention encode block and (ii) a second sub-layer has a feed forward add & norm block, which can be a position-wise fully connected feed-forward network. The feed forward add & norm block can use a rectified linear unit (ReLU).

The encoder can uses a residual connection around each of the two sub-layers, followed by an add & norm multi-head attention block, which performs normalization (e.g., the output of each sub-layer is LayerNorm (x+Sublayer (x)), i.e., the product of a layer normalization “LayerNorm” time the sum of the input “x” and output “Sublayer (x)” pf the sublayer LayerNorm (x+Sublayer (x)), where Sublayer (x) is the function implemented by the sub-layer). To facilitate these residual connections, all sub-layers in the model, as well as the embedding layers, produce output data having the same dimension.

Similarly, the decoder uses stacked self-attention and point-wise, fully connected layers. For example, the decoder can also be a stack of M identical layers (e.g., M=6), and each layer is a decode block. In addition to the two sub-layers (i.e., the sublayer with the multi-head attention encode block and the sub-layer with the feed forward add & norm block), the decode block can include a third sub-layer, which performs multi-head attention over the output of the encoder stack. Like the encoder, the decoder can use residual connections around each of the sub-layers, followed by layer normalization. Additionally, the sub-layer with the multi-head attention encode block can be modified in the decoder stack to prevent positions from attending to subsequent positions. This masking, combined with fact that the output embeddings are offset by one position, ensures that the predictions for position “i” can depend only on the known output data at positions less than “i”.

The linear block can be a learned linear transfor-mation. For example, when the transformer architecture is used to predict the next event in the network data, and the linear block projects the output from the last decode block into event scores representing likelihoods of the next event in the network data, which enables detecting anomalous behavior corresponding to a lower trust score. For instance, if there are 10,000 possible next events, then 10,000 score values are generated. If there three next events are predicted (i.e., event (N), event (N+1), and event (N+2)), the 10,000 score values would be generated for each position, i.e., each of event (N), event (N+1), and event (N+2). The score values indicate the likelihood of occurrence for each event in the vocabulary of events in that position of the event sequence.

A softmax block can be applied to the scores from the linear block to generate output probabilities (which add up to 1.0). In each position, the index provides for the event with the highest probability, and then map that index to the corresponding word in the vocabulary (e.g., a likelihood indicating whether the next value in the network data indicates a normal or an anomalous behavior). Those events then form the output sequence of the transformer architecture. The softmax operation is applied to the output from the linear block to convert the raw numbers into the output probabilities (e.g., token probabilities).

FIG. 7B illustrates an example of using the trained ML model 708. The network data 706 is applied to the trained ML model 708 to generate various outputs, which can include the trust score 710.

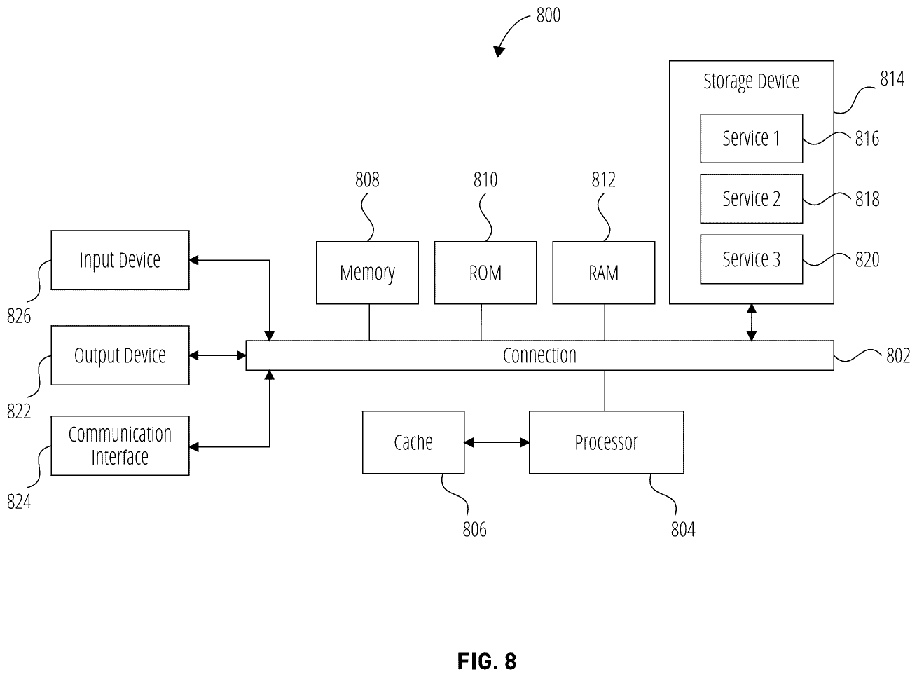

FIG. 8 shows an example of computing system 800. The computing system 800 can be one or more of the components of the network 100, the data center 200, the computer network 300, or the network 400. The computing system 800 can perform the functions of one or more of the components of the network 100, the data center 200, the computer network 300, or the network 400. The computing system 800 can be part of a distributed computing network in which several computers perform respective steps in method 600 and/or the functions of one or more of the components of the network 100, the data center 200, the computer network 300, or the network 400. The computing system 800 can be connected to the other parts of the distributed computing network via connection 802 or communication interface 824. Connection 802 can be a physical connection via a bus, or a direct connection into processor 804, such as in a chipset architecture. Connection 802 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 800 includes at least one processing unit (CPU or processor) 804 and connection 802 that couples various system components including system memory 808, such as read-only memory (ROM) 810 and random access memory (RAM) 812 to processor 804. Computing system 800 can include a cache of high-speed memory 806 connected directly with, in close proximity to, or integrated as part of processor 804. Processor 804 may essentially be a completely self-contained computing system, containing multiple cores or processors, a bus, memory controller, cache, etc. A multi-core processor may be symmetric or asymmetric.

Processor 804 can include any general-purpose processor and a hardware service or software service, such as services 816, 818, and 820 stored in storage device 814, configured to control processor 804 as well as a special-purpose processor where software instructions are incorporated into the actual processor design.

To enable user interaction, computing system 800 includes an input device 826, which can represent any number of input mechanisms, such as a microphone for speech, a touch-sensitive screen for gesture or graphical input, keyboard, mouse, motion input, speech, etc. Computing system 800 can also include output device 822, which can be one or more of a number of output mechanisms known to those of skill in the art. In some instances, multimodal systems can enable a user to provide multiple types of input/output to communicate with computing system 800. Computing system 800 can include a communication interface 824, which can generally govern and manage the user input and system output. There is no restriction on operating on any particular hardware arrangement, and therefore the basic features here may easily be substituted for improved hardware or firmware arrangements as they are developed.

Storage device 814 can be a non-volatile memory device and can be a hard disk or other types of computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

The storage device 814 can include software services, servers, services, etc., that, when the code that defines such software is executed by the processor 804, it causes the system to perform a function. In some embodiments, a hardware service that performs a particular function can include the software component stored in a computer-readable medium in connection with the necessary hardware components, such processor 804, connection 802, output device 822, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in a memory of a component of the network 100, the data center 200, the computer network 300, or the network 400 and performs one or more functions of method 600 when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data that cause or otherwise configure a general-purpose computer, special-purpose computer, or special-purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, For example, instructions and data which cause or otherwise configure a general purpose computer, special purpose computer, or special purpose processing device to perform a certain function or group of functions. Portions of computer resources used can be accessible over a network. The computer executable instructions may be, For example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method of routing traffic in a network based on trust scores, the method comprising:
assigning trust scores to respective nodes within a network;
determining, based on the trust scores, one or more preferred routes for one or more data packets through the network, the one or more preferred routes starting at a first node and ending at a second node, and the one or more preferred routes being determined based on a respective cumulative metric for each potential route that accounts for the trust scores of nodes along the potential route; and
routing the one or more data packets along the one or more preferred routes based at least in part on load balancing a volume of traffic.

2. The method of claim 1, wherein determining the one or more preferred routes based on the trust scores further comprises:
determining the one or more preferred routes based on the trust scores and based on a degree of data sensitivity of the one or more data packets, such that load balancing is achieved by:
routing a first traffic flow of the one or more data packets along a first route, wherein the first traffic flow has a higher degree of the data sensitivity than a second traffic flow, and
routing a part of the second traffic flow along a second route that is less trustworthy than the first route, when a packet routing capacity of the first route is exceeded by a combination of the first traffic flow and the second traffic flow.

3. The method of claim 1, wherein assigning the trust scores to respective nodes within the network further comprises:
receiving, at one or more processors, network data representing indicia of trustworthiness at the respective nodes of the network;
applying the network data of a first node to a first machine learning (ML) model to determine a first trust score, and repeating for each of the respective nodes of the network to determine the trust scores using the ML model; and
assigning the determined trust scores to the respective nodes of the network.

4. The method of claim 3, wherein the first trust score represents a consistency of the first node to stably transmit data through the first node while preserving an integrity of the data.

5. The method of claim 3, wherein the network data for a given node of the network compromises one or more of: (i) telemetry data from the given node; (ii) packet latency through the given node; (iii) packet loss rate at the given node; (iv) results of deep packet inspection at the given node; (v) a number of successful transactions the given node; (vi) response time of the given node; (vii) incidence of security breaches or data leak at the given node; (viii) a software version installed on the given node; (ix) security patches installed on the given node; (x) detections of potential security threats, vulnerabilities, bugs, or attacks; exposures to other nodes suspected of compromise; (xi) number of connections to neighboring nodes; (xii) time of operating in a proper manner; (xiii) network policies at the given node; (xiv) statistical fluctuations in performance at the given node; (xv) a packet size or distribution of packet sizes, and/or (xvi) anomalous events detected at the given node.

6. The method of claim 3, wherein the ML model comprises a decision tree model, a regression model, a classifier models, a clustering model, a K-means clustering model, a K-nearest neighbor clustering model, a reinforcement learning model, a Q-learning model, a large language model, and/or a transformer model.

7. The method of claim 1, wherein determining the one or more preferred routes based on the trust scores further comprises:
optimizing an objective function that comprises a trust term and a load balancing term, the objective function representing scores for potential routes, wherein the trust term for a potential route combines the trust scores of the nodes along the potential route into the cumulative metric, and
the load balancing term accounts for bottlenecks and limitations arising from traffic-flow capacities of the potential route.

8. The method of claim 7, wherein the cumulative metric is an LA-norm of the trust scores of the nodes along the potential route.

9. The method of claim 1, wherein determining the one or more preferred routes based on the trust scores further comprises:
determining the one or more preferred routes piecewise by:
determining, for each local region of the network, one or more preferred route segments through a local region of the network; and
forming the one or more preferred routes by integrating the one or more preferred route segments from a first local region with the one or more preferred route segments from one or more other local regions.

10. The method of claim 1, further comprising:
determining whether a trust score of a node is within a first range of values, a second range of values, or a third range of values;
treating the node as compromised by quarantining the node, when the trust score of the node is within the first range of values;
treating the node as suspicious, when the trust score of the node is within the second range of values, by adding observability functions to the node that provide additional information regarding potential problems on the node; and
treating the node as normal, when the trust score of the node is within the second range of values, by continuing to monitor network data from the node and updating a value of the trust score of the node based on the network data.

11. A computing apparatus comprising:
a processor; and
a memory storing instructions that, when executed by the processor, configure the apparatus to:
assign trust scores to respective nodes within a network;
determine, based on the trust scores, one or more preferred routes for one or more data packets through the network, the one or more preferred routes starting a first node and ending at a second node, and the one or more preferred routes being determined based on a respective cumulative metric for each potential route that accounts for the trust scores of nodes along the potential route; and
route the one or more data packets along the one or more preferred routes based at least in part on load balancing a volume of traffic.

12. The computing apparatus of claim 11, wherein the instructions stored in the memory, when executed by the processor, to determine the one or more preferred routes based on the trust scores by further configuring the apparatus to:
determine the one or more preferred routes based on the trust scores and based on a degree of data sensitivity of the one or more data packets; and
perform load balancing by further configuring the apparatus to:
route a first traffic flow of the one or more data packets along a first route, wherein the first traffic flow has a higher degree of the data sensitivity than a second traffic flow, and
route a part of the second traffic flow along a second route that is less trustworthy than the first route, when a packet routing capacity of the first route is exceeded by a combination of the first traffic flow and the second traffic flow.

13. The computing apparatus of claim 11, wherein the instructions stored in the memory, when executed by the processor, assign the trust scores to respective nodes within the network by further configuring the apparatus to:
receive, at one or more processors, network data representing indicia of trustworthiness at the respective nodes of the network;
apply the network data of a first node to a first machine learning (ML) model to determine a first trust, and repeating for each of the respective nodes of the network to determine the trust scores using the ML model; and
assign the determined trust scores to the respective nodes of the network.

14. The computing apparatus of claim 13, wherein the ML model comprises a decision tree model, a regression model, a classifier models, a clustering model, a K-means clustering model, a K-nearest neighbor clustering model, a reinforcement learning model, a Q-learning model, a large language model, or a transformer model.

15. The computing apparatus of claim 13, wherein a first trust score represents a consistency of the first node to stably transmit data through the first node while preserving an integrity of the data.

16. The computing apparatus of claim 11, wherein the instructions stored in the memory, when executed by the processor, determine the one or more preferred routes based on the trust scores by further configuring the apparatus to:
optimize an objective function that comprises a trust term and a load balancing term, the objective function representing scores for potential routes, wherein the trust term for a potential route combines the trust scores of the nodes along the potential route into the cumulative metric, and
the load balancing term accounts for bottlenecks and limitations arising from traffic-flow capacities of the potential route, wherein the cumulative metric is an L^{p}-norm of the trust scores of the nodes along the potential route.

17. The computing apparatus of claim 16, wherein the objective function is a weighted combination comprising the trust term and the load balancing terms, and
weights for the weighted combination are based on a degree of data sensitivity and/or data criticality of the one or more data packets.

18. The computing apparatus of claim 11, wherein the instructions stored in the memory, when executed by the processor, determine the one or more preferred routes in a piecewise manner by further configuring the apparatus to:
determine, for each local region of the network, one or more preferred route segments through a local region of the network; and
form the one or more preferred routes by integrating the one or more preferred route segments from a first local region with the one or more preferred route segments from one or more other local regions.

19. A non-transitory computer-readable storage medium, the computer-readable storage medium including instructions that when executed by a computer, cause the computer to:
assign trust scores to respective nodes within a network;
determine, based on the trust scores, one or more preferred routes for one or more data packets through the network, the one or more preferred routes starting a first node and ending at a second node, and the one or more preferred routes being determined based on a respective cumulative metric for each potential route that accounts for the trust scores of nodes along the potential route; and
route the one or more data packets along the one or more preferred routes based at least in part on load balancing a volume of traffic.

20. The non-transitory computer-readable storage medium of claim 19, wherein the instructions on the computer-readable storage medium further configure the computer to:
determine the one or more preferred routes based on the trust scores and based on a degree of data sensitivity of the one or more data packets; and
perform load balancing is achieved by further configuring the computer to:
route a first traffic flow of the one or more data packets along a first route, wherein the first traffic flow has a higher degree of the data sensitivity than a second traffic flow, and
route a part of the second traffic flow along a second route that is less trustworthy than the first route, when a packet routing capacity of the first route is exceeded by a combination of the first traffic flow and the second traffic flow.
